(19) United States
(12) Patent Application Publication
(10) Pub. No.: US 2020/0331286 A1
(43) Pub. Date: Oct. 22, 2020

(54) MULTI-FUNCTION APPARATUS

(71) Applicants: Reza Lavasanijou, Cleveland, OH (US); Farbod Rohani, Lakewood, OH (US)

(72) Inventors: Reza Lavasanijou, Cleveland, OH (US); Farbod Rohani, Lakewood, OH (US)

(21) Appl. No.: 16/709,953

(22) Filed: Dec. 11, 2019

Related U.S. Application Data
(60) Provisional application No. 62/836,672, filed on Apr. 21, 2019.

(51) Int. Cl. B43L 23/00; B25C 5/02; B26D 5/08; B26F 1/38; B23Q 11/00

(52) U.S. Cl. CPC B43L 23/008; B25C 5/0214; B25C 5/0228; B26D 2007/0018; B26F 1/3846; B23Q 11/0046; B26D 5/086

(57) ABSTRACT

One or more apparatuses, computing devices and/or systems are provided. In an example, an apparatus is provided. The apparatus may comprise a sharpener device configured to sharpen a pencil. The apparatus may comprise a hole puncher device configured to punch one or more holes in one or more sheets of paper. The apparatus may comprise an indentation at a corner of the apparatus. The apparatus may comprise a stapler device overlying the indentation. The stapler device may be configured to couple sheets of paper together by driving a staple through the sheets of paper at a point within the indentation. The apparatus may comprise a tray configured to collect shavings from the sharpener device and/or chips from the hole puncher device. The apparatus may comprise a vacuum device configured to apply suction to conduct material (e.g., shavings and/or chips) from the tray.

### RELATED APPLICATION

This application claims the benefit of U.S. Provisional Application No. 62/836,672, filed Apr. 21, 2019, which is incorporated herein by reference in its entirety.

### BACKGROUND

Home and office equipment, such as hole punchers, staplers, pencil sharpeners, etc. may be used for various purposes. However, such home and office equipment are often separate components and can be hard to keep track of.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, an apparatus is provided. In some examples, the apparatus may comprise a sharpener device configured to sharpen a pencil. The sharpener device may be electrically powered by a first power source. In some examples, the apparatus may comprise a tray configured to collect shavings from the sharpener device. In some examples, the apparatus may comprise a vacuum device configured to apply suction to conduct material from within the tray to a collecting space within the vacuum device. In some examples, the material comprises shavings within the tray. In some examples, the vacuum device is electrically powered by the first power source.

In an example, an apparatus is provided. In some examples, the apparatus may comprise a hole puncher device configured to punch one or more holes in one or more sheets of paper. In some examples, the hole puncher device is electrically powered by a first power source. In some examples, the apparatus may comprise a tray configured to collect chips from the hole puncher device. In some examples, the apparatus may comprise a vacuum device configured to apply suction to conduct material from within the tray to a collecting space within the vacuum device. In some examples, the material comprises chips within the tray. In some examples, the vacuum device is electrically powered by the first power source.

In an example, an apparatus is provided. In some examples, the apparatus may comprise a hole puncher device configured to punch one or more holes in one or more sheets of paper. In some examples, the hole puncher device is electrically powered by a first power source. In some examples, the apparatus may comprise a sharpener device configured to sharpen a pencil. In some examples, the sharpener device is electrically powered by the first power source.

In an example, an apparatus is provided. In some examples, the apparatus may comprise a sharpener device configured to sharpen a pencil. In some examples, the sharpener device is electrically powered by a first power source. In some examples, the apparatus may comprise an indentation at a corner of the apparatus. In some examples, the apparatus may comprise a stapler device overlying the indentation. In some examples, the stapler device is configured to couple sheets of paper together by driving a staple through the sheets of paper at a point within the indentation. In some examples, the stapler device is electrically powered by the first power source.

In an example, an apparatus is provided. In some examples, the apparatus may comprise a hole puncher device configured to punch one or more holes in one or more sheets of paper. In some examples, the hole puncher device is electrically powered by a first power source. In some examples, the apparatus may comprise an indentation at a corner of the apparatus. In some examples, the apparatus may comprise a stapler device overlying the indentation. In some examples, the stapler device is configured to couple sheets of paper together by driving a staple through the sheets of paper at a point within the indentation. In some examples, the stapler device is electrically powered by the first power source.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is an illustration of a perspective view of an apparatus.

FIG. 1B is an illustration of a first side of an apparatus.

FIG. 1C is an illustration of a second side of an apparatus.

FIG. 1D is an illustration of a third side of an apparatus.

FIG. 1E is an illustration of a fourth side of an apparatus.

FIG. 2A is an illustration of a plurality of punches of a hole puncher device.

FIG. 2B is an illustration of an embodiment of an apparatus comprising a plurality of lights associated with a plurality of punches.

FIG. 2C is an illustration of an exemplary scenario where a hole configuration setting of one or more hole punch settings corresponds to a first hole configuration associated with a first set of punches.

FIG. 2D is an illustration of an embodiment of a hole puncher device comprising a guide.

FIG. 2E is an illustration of an embodiment of a hole puncher device, where one or more punches of a plurality of punches are comprised within one or more first arms.

FIG. 3A is an illustration of an embodiment of a sharpener device comprising a shutter device.

FIG. 3B is an illustration of an embodiment of a sharpener device comprising a shutter device, where the shutter device is in an open state.

FIG. 3C is an illustration of an embodiment of a sharpener device comprising a shutter device, where the shutter device is in an enclosing state.

FIG. 3D is an illustration of a first pencil within a sharpener device.

FIG. 4A is an illustration of an embodiment of a vacuum device.

FIG. 4B is an illustration of a plurality of vacuum attachments.

FIG. 4C is an illustration of a section of an apparatus enclosing a tray.

FIG. 4D is an illustration of an embodiment of a tray.

FIG. 5A is an illustration of a first embodiment of a scanning module of an apparatus.

FIG. 5B is an illustration of a second embodiment of a scanning module of an apparatus.

FIG. 5C is an illustration of a second embodiment of a scanning module of an apparatus.

FIG. 6A is an illustration of an embodiment of an interface device of an apparatus.

FIG. 6B is an illustration of an embodiment of an interface device of an apparatus.

FIG. 7 illustrates an embodiment of an apparatus comprising a second plurality of lights.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of mechanical devices, electro-mechanical devices, electrical devices or any combination thereof.

It may be appreciated that “sheet of paper” as used herein may refer to a piece of book paper, a piece of printing paper, a piece of writing paper, a piece of cardboard, a piece of bank paper, a piece of banana paper, a piece of bond paper, a piece of coated paper, a piece of cotton paper, a piece of construction paper, a piece of construction paper, a piece of fish paper, a piece of inkjet paper, a piece of laid paper, a piece of leather paper, a piece of sandpaper, a piece of wallpaper, a piece of waterproof paper, a piece of wax paper, a piece of hemp paper, a piece of wrapping paper, a different type of paper, an index card and/or a different type of card.

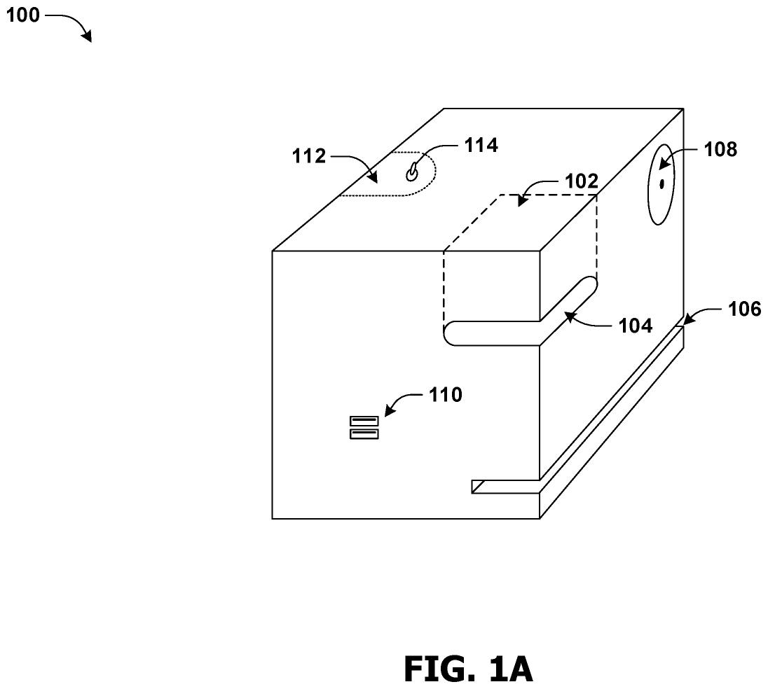

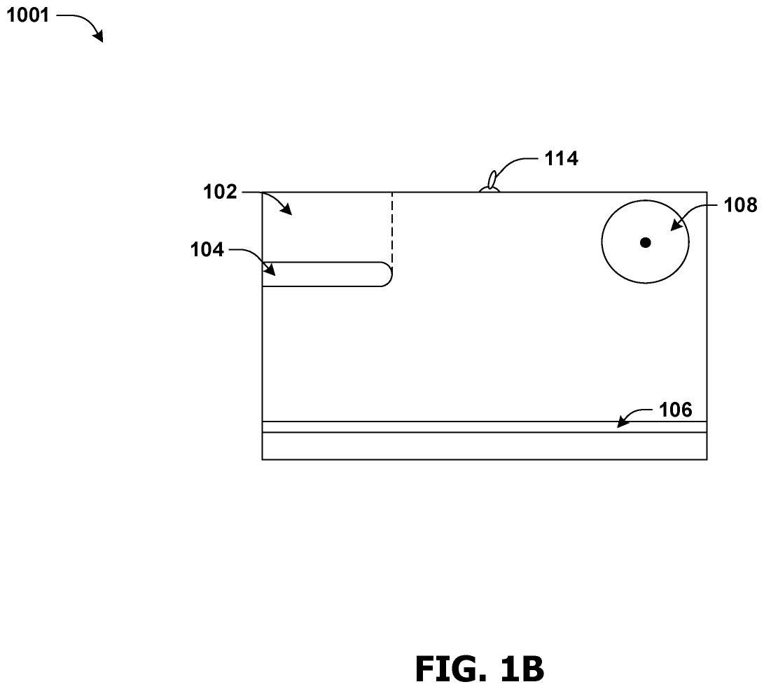

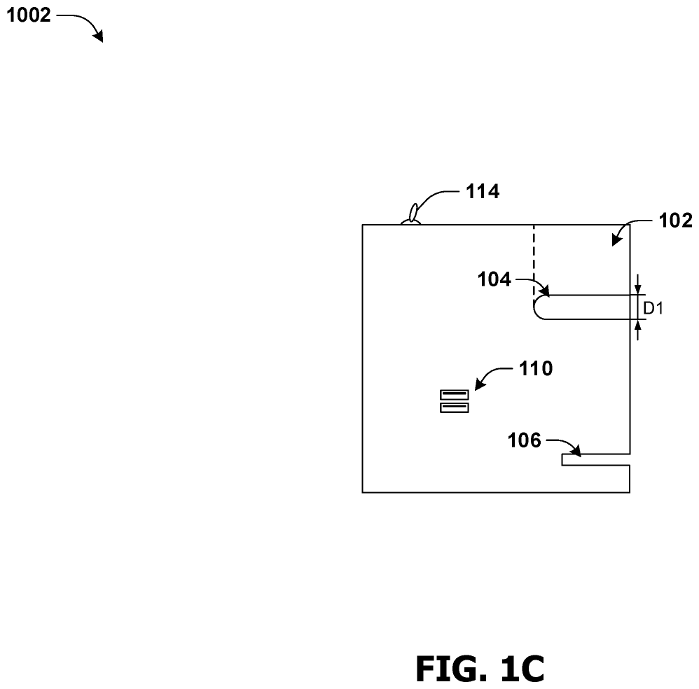

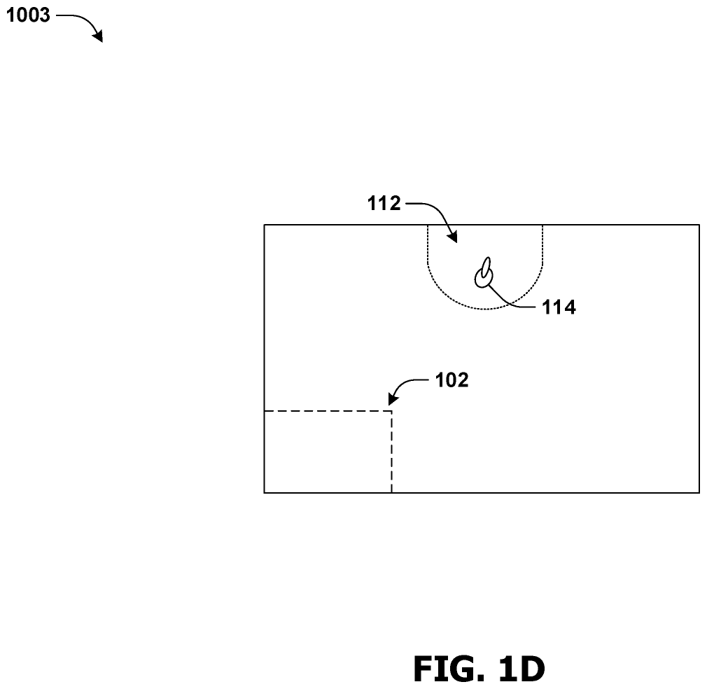

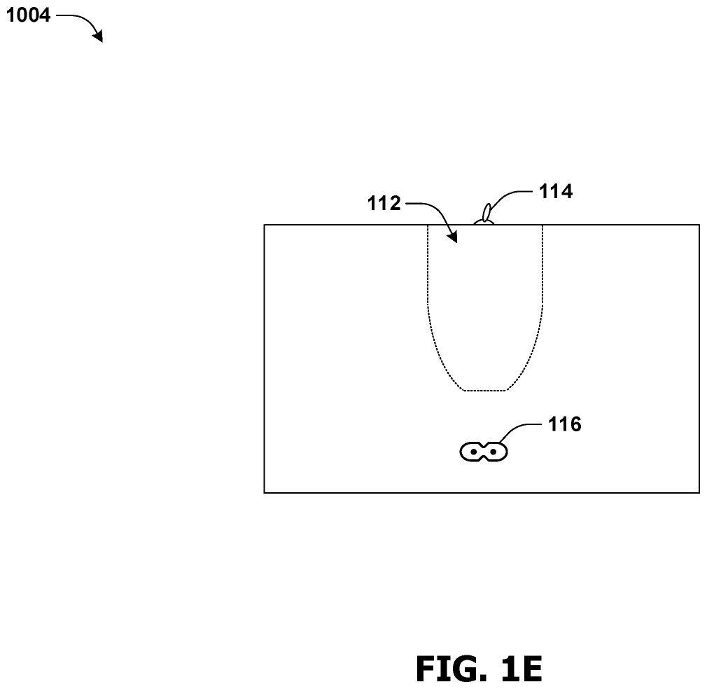

FIGS. 1A-1E present an apparatus 100. FIG. 1A illustrates a perspective view of the apparatus 100. FIG. 1B illustrates a first side 1001 of the apparatus 100. The first side 1001 is also apparent in the perspective view of FIG. 1A. FIG. 1C illustrates a second side 1002 of the apparatus 100. The second side 1002 is also apparent in the perspective view of FIG. 1A. FIG. 1D illustrates a third side 1003 of the apparatus 100. The third side 1003 is also apparent in the perspective view of FIG. 1A. FIG. 1 E illustrates a fourth side 1004 of the apparatus 100. The fourth side 1004 may be on an opposite side of the apparatus 100 as the first side 1001.

For example, the apparatus 100 may be used in workplaces, office areas, industrial areas, educational institutions (e.g., schools, colleges, universities, etc.), etc. for at least one of hole punching sheets of paper, stapling sheets of paper together, sharpening pencils, scanning documents, etc. Alternatively and/or additionally, the apparatus 100 may be used in households as a home appliance.

The apparatus 100 may comprise a sharpener device 108 (illustrated in FIGS. 1A-1B), a vacuum device 112 (illustrated in FIG. 1A and FIGS. 1D-1E), a switch 114 (illustrated in FIGS. 1A-1E), a hole puncher device 106 (illustrated in FIGS. 1A-1C), an indentation 104 (illustrated in FIGS. 1A-1C), a stapler device 102 (illustrated in FIGS. 1A-1D), one or more connection ports 110 (illustrated in FIG. 1A and FIG. 1C) and/or a power connection port 116 (illustrated in FIG. 1E).

In an embodiment, the apparatus 100 may comprise the sharpener device 108, the vacuum device 112, the hole puncher device 106, the indentation 104 and the stapler device 102.

In another embodiment, the apparatus 100 may comprise the sharpener device 108 and the vacuum device 112, but not the hole puncher device 106, the indentation 104 and the stapler device 102.

In another embodiment, the apparatus 100 may comprise the hole puncher device 106 and the vacuum device 112, but not the sharpener device 108, the indentation 104 and the stapler device 102.

In another embodiment, the apparatus 100 may comprise the hole puncher device 106, the indentation 104 and the stapler device 102, but not the sharpener device 108 and the vacuum device 112.

In another embodiment, the apparatus 100 may comprise the hole puncher device 106, the indentation 104, the stapler device 102 and the vacuum device 112, but not the sharpener device 108.

In another embodiment, the apparatus 100 may comprise the hole puncher device 106, the indentation 104 and the stapler device 102, but not the sharpener device 108 and the vacuum device 112.

In another embodiment, the apparatus 100 may comprise the hole puncher device 106, the indentation 104, the stapler device 102 and the vacuum device 112, but not the sharpener device 108.

In another embodiment, the apparatus 100 may comprise the sharpener device 108, the indentation 104 and the stapler device 102, but not the hole puncher device 106 and the vacuum device 112.

In another embodiment, the apparatus 100 may comprise the sharpener device 108, the indentation 104, the stapler device 102 and the vacuum device 112, but not the hole puncher device 106.

In some examples, the sharpener device 108 may be configured to sharpen pencils. The sharpener device 108 may be electrically powered by a first power source. In some examples, the first power source may correspond to a portable power source (e.g., a high-voltage power supply, a battery, etc.) comprised within the apparatus 100. For example, the portable power source may comprise an alternating current (AC) battery (e.g., a battery connected to a bi-directional inverter) and/or a direct current (DC) battery. Alternatively and/or additionally, the first power source may correspond to an external power source (e.g., an AC network, an external battery, etc.) via one or more connecters (e.g., a power port, a plug, an outlet, etc.). In some examples, the sharpener device 108 may be directly connected to the external power source (e.g., sharpener device 108 may be electrically powered via a direct connection to the external power source). Alternatively and/or additionally, the apparatus 100 may comprise one or more regulators and/or one or more power adapters electrically connected to the external power source. The one or more regulators and/or the one or more power adapters may be configured to regulate voltage and/or current to the sharpener device 108 (and/or to one or more other components of the apparatus 100).

In some examples, the apparatus 100 may be connected to external power source via the power connection port 116. For example, a first end of a power cable may be connected to the power connection port 116 and/or a second end of the power cable may be connected to the external power source. Alternatively and/or additionally, the apparatus 100 may not comprise the power connection port 116. For example, the apparatus 100 may comprise the power cable (which may extend from the apparatus 100 to the external power source). In an example where the apparatus is electrically powered by the portable power source, the portable power source may be charged (e.g., recharged) using power received from the external power source.

In some examples, the hole puncher device 106 may be configured to punch one or more holes in one or more sheets of paper. The hole puncher device 106 may be electrically powered by the first power source (and/or a different power source).

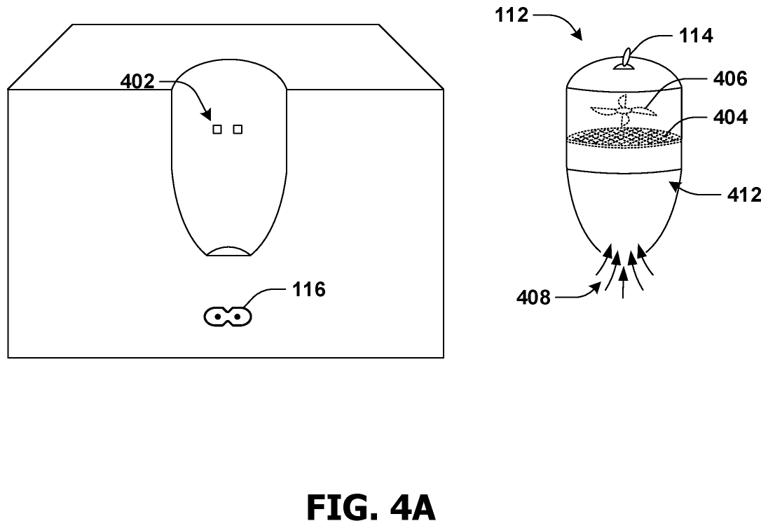

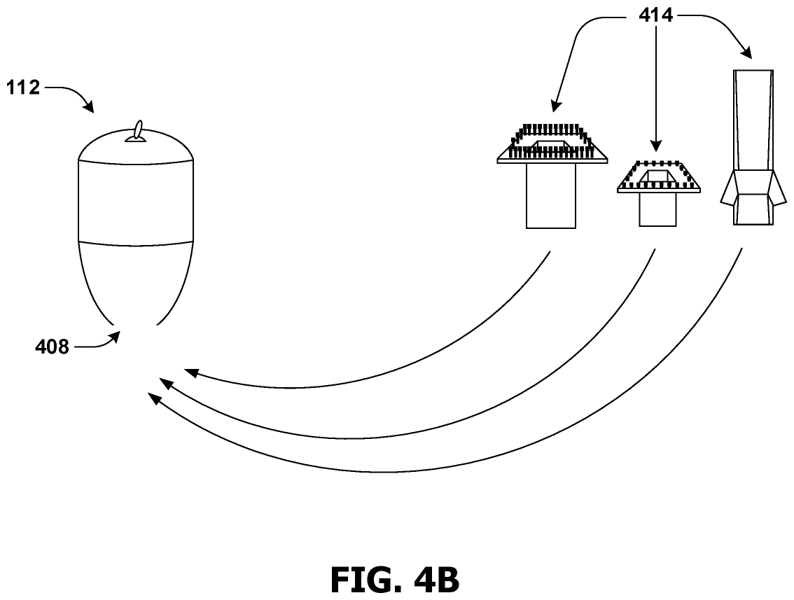

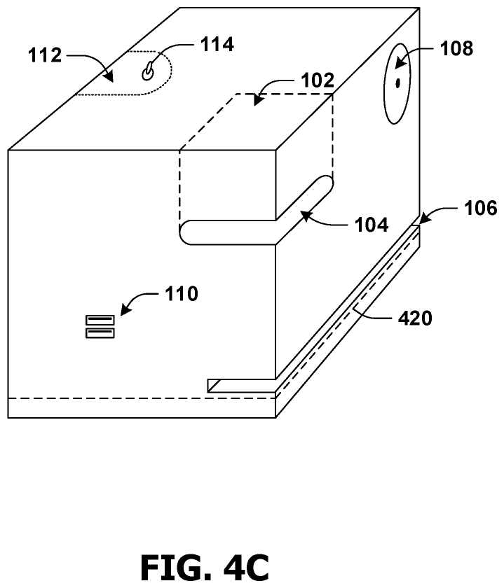

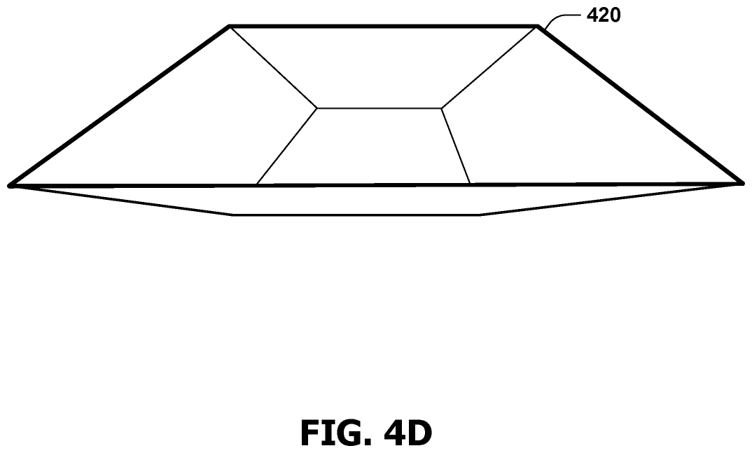

In some examples, the apparatus 100 may comprise a tray 420 (illustrated in FIGS. 4C-4D). The tray 420 may be configured to collect shavings from the sharpener device 108 and/or chips from the hole puncher device 106.

In some examples, the vacuum device 112 may be configured to apply suction to conduct material from within the tray 420 to a collecting space within the vacuum device 112. The material may comprise shavings (from the sharpener device 108) and/or chips (from the hole puncher device 106). The vacuum device 112 may be electrically powered by the first power source (and/or a different power source).

In some examples, the stapler device 102 may overly the indentation 104. The stapler device 102 may be configured to couple sheets of paper together by driving a staple through the sheets of paper at a point within the indentation 104. The stapler device 102 may be electrically powered by the first power source (and/or a different power source).

In some examples, the apparatus 100 and/or one or more components of the apparatus 100 (e.g., the one or more components may comprise at least one of the sharpener device 108, the vacuum device 112, the hole puncher device 106, the stapler device 102, etc.) may be controlled via a plurality of switches. The plurality of switches may comprise one or more toggle switches. Alternatively and/or additionally, the plurality of switches may comprise one or more push-button switches (e.g., normally open and/or normally closed push-button switches). The plurality of switches may be used for activating a component of the one or more components (e.g., turning on and/or running the component). For example, responsive to activation of a switch of the plurality of switches (e.g., activation of the switch may correspond to switching the switch to an on-state), a component associated with the switch may become activated. For example, responsive to activation of the switch, a controller of the apparatus 100 may provide electrical power to the component associated with the switch.

An example of a switch of the plurality of switches may correspond to the switch 114 associated with the vacuum device 112. Responsive to activation of the switch 114 (e.g., switching the switch 114 to an on-state), electrical power may be provided to the vacuum device 112 and/or the vacuum device 112 may become activated. Activation of the vacuum device 112 may correspond to the vacuum device 112 applying suction to conduct material from within the tray 420 to the collecting space within the vacuum device 112. Responsive to deactivation of the switch 114 (e.g., switching the switch 114 to an off-state), the controller may stop providing electrical power to the vacuum device 112 and/or the vacuum device 112 may become deactivated (e.g., the vacuum device 112 may no longer apply suction).

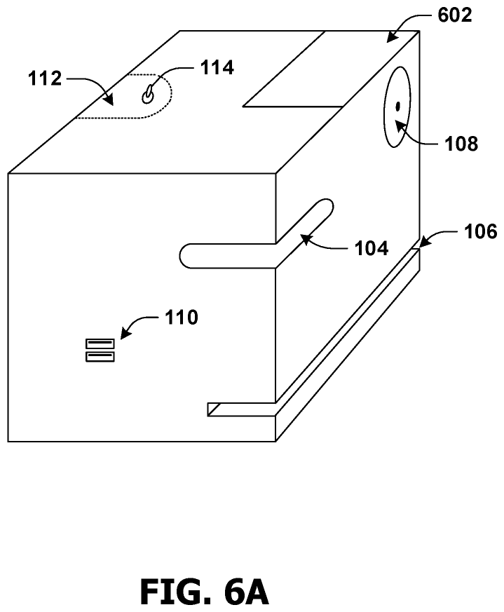

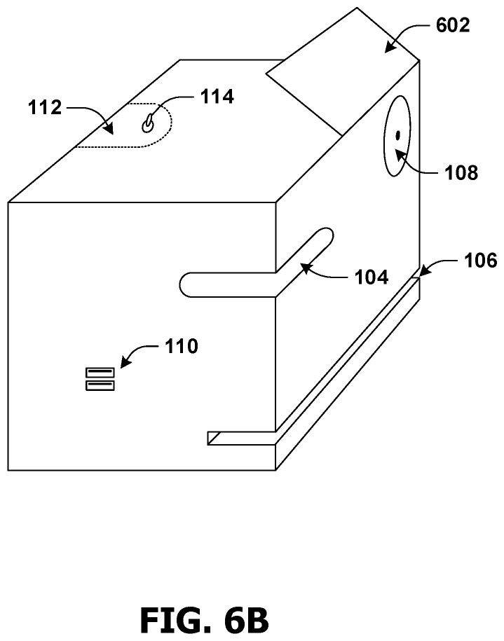

Alternatively and/or additionally, the apparatus 100 and/or the one or more components of the apparatus 100 may be controlled via at least one of a graphical user interface (e.g., the graphical user interface may be displayed via an interface device 602 illustrated in FIGS. 6A-6B), a conversational interface, a voice interface, a projection interface, etc.

In an example where the apparatus 100 and/or the one or more components of the apparatus 100 are controlled via the graphical user interface, the apparatus 100 may comprise the interface device 602. For example, the graphical user interface may display one or more graphical objects. A graphical object of the one or more graphical objects may be indicative of information (e.g., the information may be indicative of one or more current settings associated with the apparatus 100, a status of a component of the apparatus 100, etc.). Alternatively and/or additionally, the one or more graphical objects may comprise one or more graphical selectable inputs corresponding to at least one of one or more commands associated with the apparatus 100, one or more settings associated with the apparatus 100, etc. For example, a command may be input to the apparatus 100 via a selection of a selectable input of the one or more graphical selectable inputs. Alternatively and/or additionally, one or more settings associated with the apparatus 100 may be changed via a selection of a selectable input of the one or more graphical selectable inputs. In some examples, a selection of a selectable input of the one or more graphical selectable inputs may be received via a selection of a physical switch and/or a physical button of the device 602. Alternatively and/or additionally, in an example where the interface device 602 comprises a touchscreen display, a selection of a selectable input of the one or more graphical selectable inputs may be received via a selection of an area of the touchscreen display corresponding to the selectable input (e.g., the selection may correspond to a finger and/or an object tapping the area of the touchscreen display on which the selectable input is displayed).

In an example where the apparatus 100 and/or the one or more components of the apparatus 100 are controlled via the voice interface and/or the conversational interface, the apparatus 100 may comprise a microphone. One or more voice commands may be input via the microphone. For example, a voice command may correspond to speech of a person corresponding to changing one or more settings of the apparatus 100. Alternatively and/or additionally, a voice command may correspond to speech of a person corresponding to initiating and/or canceling an operation of the apparatus 100 and/or the one or more components of the apparatus 100. In an example, the apparatus 100 may continuously and/or periodically monitor audio recorded by the microphone. In some examples, the apparatus 100 may be configured to detect speech while monitoring the audio. Responsive to detecting a sound and/or speech, an audio segment comprising the sound and/or the speech may be extracted and/or analyzed. For example, the audio segment may be compared with the one or more voice commands to determine whether the audio segment matches (e.g., is similar to) a voice command of a plurality of voice commands. Responsive to determining that the audio segment does not match a voice command of the plurality of voice commands, the audio segment may be discarded (and/or the apparatus 100 may continue monitoring audio recorded by the microphone).

In an example where the apparatus 100 and/or the one or more components of the apparatus 100 are controlled via the projection interface, the apparatus 100 may comprise a projection device. The projection device may comprise a projection module, an illumination module, a laser and/or a beamer configured to project the projection interface onto a surface. For example, the surface may correspond to a desktop and/or a tabletop on which the apparatus 100 is positioned. Alternatively and/or additionally, the surface may correspond to a wall and/or a ceiling. The projection interface may comprise one or more projected selectable inputs. The one or more projected selectable inputs may correspond to at least one of one or more commands associated with the apparatus 100, one or more settings associated with the apparatus 100, one or more keys of a keyboard, etc. For example, a command may be input to the apparatus 100 via a selection of a selectable input of the one or more projected selectable inputs. Alternatively and/or additionally, one or more settings associated with the apparatus 100 may be changed via a selection of a selectable input of the one or more projected selectable inputs. In some examples, the projection interface may display information associated with the apparatus 100 (e.g., the information may be indicative of one or more current settings associated with the apparatus 100, a status of a component of the apparatus 100, etc.). The projection device may comprise a sensor (e.g., at least one of an optical sensor, a camera, a motion sensor, etc.) configured to detect and/or monitor movements and/or coordinates of objects (e.g., fingers) near and/or above the projection interface. Responsive to an object (such as a finger) touching a part of the surface covered by an image of a selectable input of the one or more projected selectable inputs, a selection of the selectable input may be recorded by the apparatus 100.

In some examples, the projection interface may be projected onto a plurality of surfaces. For example, a first portion of the projection interface may be projected onto a first surface (e.g., a tabletop, a wall and/or a ceiling). A second portion of the projection interface may be projected onto a second surface (e.g., a tabletop, a wall and/or a ceiling). In an example, the first portion of the projection interface may be projected onto a wall and/or a ceiling and/or the first portion of the projection interface may comprise at least a portion of the one or more projected selectable inputs. In the example, the second portion of the projection interface may be projected onto a tabletop and/or the second portion of the projection interface may comprise at least some of the information.

Alternatively and/or additionally, the apparatus 100 and/or the one or more components of the apparatus 100 may be controlled via a client device (e.g., at least one of a phone, a laptop, a smartphone, a tablet, a computer, a wearable computer, a smart television, a device that runs a virtual assistant, etc.). In some examples, the client device may display a control interface associated with the apparatus 100. The apparatus 100 may perform operations responsive to interactions with the control interface on the client device (e.g., the interactions may correspond to selections of one or more selectable inputs corresponding to one or more commands associated with the apparatus 100 and/or one or more settings associated with the apparatus 100). Alternatively and/or additionally, the control interface may display information associated with the apparatus 100 (e.g., the information may be indicative of one or more current settings associated with the apparatus 100, a status of a component of the apparatus 100, etc.). For example, the apparatus 100 may be connected to the client device via a wireless connection and/or a wired connection. The apparatus 100 may receive information (e.g., settings information, instructions and/or commands) from the client device via the wireless connection and/or the wired connection. In an example, the wired connection may be established via a wired connection (e.g., at least one of an Ethernet connection, a Fiber Channel connection, a Universal Serial Bus (USB) connection, etc.) to the client device and/or to a local area network. In an example, the wireless connection may be established via a wide area network, such as a public wide-area network (e.g., the Internet) and/or a private network (e.g., a virtual private network (VPN) of a distributed enterprise). Alternatively and/or additionally, the wireless connection may be established via a wireless network provided by a cellular provider (e.g., a second-generation cellular technology (2G) wireless network, a third-generation cellular technology (3G) wireless network, a fourth-generation cellular technology (4G) wireless network, a fifth-generation cellular technology (5G) wireless network, etc.). Alternatively and/or additionally, the wireless connection may be established via a wireless local area network at a location of the apparatus 100 (e.g., a Wi-Fi network and/or a Bluetooth personal area network). Alternatively and/or additionally, the wireless connection may be established using Bluetooth Low Energy technology and/or Bluetooth mesh networking technology.

In some examples, at least one connection port of the one or more connection ports 110 may comprise a USB port (e.g., at least one of a standard USB port, a mini USB port, a micro USB port, a USB-C port, etc.). Alternatively and/or additionally, at least one connection port of the one or more connection ports 110 may comprise a type of connection port different than the USB port.

In some examples, the one or more connection ports 110 may comprise one or more charging ports. For example, a battery of a client device (e.g., at least one of a phone, a laptop, a smartphone, a tablet, a computer, a wearable computer, a device that runs a virtual assistant, etc.) may be charged via connection to a charging port of the one or more charging ports. For example, the apparatus may comprise one or more power adapters that provide electrical power to the client device via the charging port (and/or via a charging cable connected to the charging port and/or the client device). Alternatively and/or additionally, the one or more connection ports 110 may comprise one or more power plugs (e.g., AC power plugs and/or AC power sockets) for connection to electric equipment. For example, the apparatus 100 may provide AC power (such as AC power supplied by the external power source) to the electric equipment via the one or more power plugs.

Alternatively and/or additionally, the one or more connection ports 110 may comprise one or more communication ports. For example, a wired connection may be established between the apparatus 100 and a client device (e.g., at least one of a phone, a laptop, a smartphone, a tablet, a computer, a wearable computer, a smart television, a device that runs a virtual assistant, etc.) via a communication port of the one or more communication ports.

In some examples, the apparatus 100 may comprise a memory unit (e.g., a hard drive) and/or a data retrieval computer connected to the one or more communication ports. The data retrieval computer may be configured to retrieve data comprised within a device connected to a communication port and/or store the data within the memory unit. In an example, the device may comprise at least one of a flash drive, an external hard drive, a phone, a laptop, a smartphone, a tablet, a computer, a wearable computer, a smart television, a device that runs a virtual assistant, etc. In some examples, the data retrieval computer may be configured to retrieve the data comprised within the device automatically responsive to establishment of a connection between the communication port and the device (e.g., responsive to a connection portion of the flash drive being connected to the communication port). Alternatively and/or additionally, the data retrieval computer may be configured to retrieve the data comprised within the device responsive to receiving a command and/or an instruction via at least one of the graphical user interface, the conversational interface, the voice interface, the projection interface, etc. In some examples, a folder may be generated having a name (e.g., a date and/or a time associated with the time that the data is retrieved), and/or the data may be stored within the folder on the memory unit.

In some examples, responsive to retrieving the data and/or storing the data within the memory unit, the data may be transmitted to a server (e.g., a second memory unit connected to the local area network and/or a cloud). In some examples, the data may be transmitted to the server via at least one of a wired connection (e.g., at least one of an Ethernet connection, a Fiber Channel connection, a USB connection, etc.), the local area network, the public wide-area network (e.g., the Internet), the private network (e.g., the VPN), the wireless network provided by the cellular provider, the wireless local area network (e.g., the Wi-Fi network and/or the Bluetooth personal area network), etc. In some examples, the apparatus 100 may be configured to transmit the data to the server automatically responsive to retrieving the data comprised within the device. Alternatively and/or additionally, the apparatus 100 may be configured to transmit the data to the server responsive to receiving a command and/or an instruction via at least one of the graphical user interface, the conversational interface, the voice interface and/or the projection interface, etc. In some examples, the data may be transmitted to the server based upon one or more server identifiers (e.g., at least one of a server address, a server Internet Protocol (IP) address, etc.). In some examples, the one or more server identifiers may be received via at least one of the graphical user interface, the conversational interface, the voice interface and/or the projection interface, etc.

In some examples, data stored in the memory unit may be accessed by client devices (e.g., at least one of phones, laptops, smartphones, tablets, computers, wearable computers, smart televisions, devices that run virtual assistants, etc.). For example, the memory unit may be connected to the local area network and/or the wireless local area network. Client devices that are connected to the local area network and/or the wireless local area network may access the data stored in the memory unit. Alternatively and/or additionally, the memory unit may be connected to the public wide-area network (e.g., the Internet), the private network (e.g., the VPN) and/or the wireless network provided by the cellular provider. For example, client devices may access the data stored in the memory unit via the public wide-area network (e.g., the Internet), the private network (e.g., the VPN) and/or the wireless network provided by the cellular provider.

In some examples, a status of the apparatus 100 may be accessed by client devices (e.g., at least one of phones, laptops, smartphones, tablets, computers, wearable computers, smart televisions, devices that run virtual assistants, etc.). For example, the status of the apparatus 100 may be transmitted to the client devices via a wired connection (e.g., at least one of an Ethernet connection, a Fiber Channel connection, a USB connection, etc.) to the local area network and/or the client devices. Alternatively and/or additionally, the status of the apparatus 100 may be transmitted to the client devices via the public wide-area network (e.g., the Internet), the private network (e.g., the VPN), the wireless network provided by the cellular provider, the wireless local area network (e.g., the Wi-Fi network and/or the Bluetooth personal area network), etc. In some examples, the status may be indicative of whether a component of the one or more components of the apparatus 100 are activated (and/or in an active state). Alternatively and/or additionally, the status may be indicative of a component of the one or more components of the apparatus 100 that is activated. Alternatively and/or additionally, the status may be indicative of the apparatus 100 being free and/or not being used (e.g., the status may be indicative of the apparatus 100 being free and/or not being used responsive to a determination that the one or more components of the apparatus 100 are not activated and/or are not in an active state). In some examples, status updates indicative of the status may be transmitted to the client devices periodically. Alternatively and/or additionally, a status update indicative of the status may be transmitted to the client devices responsive to activation and/or deactivation of the one or more components of the apparatus 100.

In some examples, the apparatus 100 may comprise an alarm system. For example, the alarm system may monitor a status of one or more client devices (e.g., at least one of phones, laptops, smartphones, tablets, computers, wearable computers, devices coupled to objects, devices used to track objects, other devices, etc.) connected to the apparatus 100. For example, the status may correspond to whether the one or more client devices are within a threshold distance to the apparatus 100. Whether a client device is within the threshold distance may be determined based upon whether the client device is connected to the apparatus 100. For example, it may be determined that a distance between the client device and the apparatus 100 exceeds the threshold distance based upon a disconnection of a connection (e.g., a Wi-Fi connection, a Bluetooth connection and/or a different type of connection) between the apparatus 100 and the client device. In some examples, responsive to determining that the client device is not within the threshold distance from the apparatus 100 and/or responsive to detecting the disconnection, the alarm system may output a notification that the client device is not within the threshold distance from the apparatus 100. In some examples, the notification may be output via the at least one of the graphical user interface, the conversational interface, the voice interface, the projection interface, etc. Alternatively and/or additionally, the notification may be transmitted to one or more client devices via at least one of a wired connection (e.g., at least one of an Ethernet connection, a Fiber Channel connection, a USB connection, etc.), the public wide-area network (e.g., the Internet), the private network (e.g., the VPN), the wireless network provided by the cellular provider, the wireless local area network (e.g., the Wi-Fi network and/or the Bluetooth personal area network), etc. It may be appreciated that outputting the notification by the alarm system may result in prevention and/or mitigation of theft of client devices and/or objects.

In some examples, the apparatus 100 may comprise a speaker configured to output audio. In some examples, the speaker may output audio stored on the memory unit. Alternatively and/or additionally, the speaker may output audio received from a client device. For example, the audio may be received from the client device via a wired connection (e.g., at least one of an Ethernet connection, a Fiber Channel connection, a USB connection, etc.), the local area network and/or the client device. Alternatively and/or additionally, the audio may be received from the client device via at least one of the public wide-area network (e.g., the Internet), the private network (e.g., the VPN), the wireless network provided by the cellular provider, the wireless local area network (e.g., the Wi-Fi network and/or the Bluetooth personal area network), etc. In some examples, audio indicative of information associated with the apparatus 100 may be output via the speaker (e.g., the information may be indicative of one or more current settings associated with the apparatus 100, a status of a component of the apparatus 100, etc.).

In some examples, the apparatus 100 may comprise an air freshening device. For example, the air freshening device may deliver air freshener mechanisms associated with at least one of adsorption (e.g., the air freshening device may deliver adsorbents such as zeolite, activated charcoal and/or silica gel to remove odors), oxidation, (e.g., the air freshening device may deliver ozone, hydrogen, peroxide, chlorine, chlorate and/or a different oxidizing agent to oxidize and/or remove organic sources of odors from surfaces and/or the air), air sanitation (e.g., the air freshening device may deliver air sanitizers that inactivate bacteria to remove odors caused by airborne bacterial activity), surfactants, soaps, masking (e.g., the air freshening device may deliver masking odors that overwhelm odors with the masking odor), etc. In some examples, the air freshener mechanisms may be delivered via at least one of piezoelectric technology, an electric fan, an aerosol spray that sprays periodically, etc.

In some examples, the apparatus 100 may comprise a drawer. For example, the drawer may hold objects, such as at least one of a ruler, a pen, a pencil, a different object, etc. In some examples, the drawer may be coupled to a sliding module. The sliding module may enable the drawer to be pulled out of the apparatus 100 (such as drawn out horizontally using one or more drawer sliders). In some examples, the sliding module may be associated with a push to open drawer configuration. For example, responsive to applying a pushing force to an external surface of the drawer, the drawer may be released and/or the sliding module may apply a force to push the drawer in a direction towards outside of the apparatus 100 (e.g., the force may be applied by a spring). In some examples, the external surface may correspond to a portion of the drawer that is visible from outside the apparatus 100 when the drawer is within the apparatus 100. Alternatively and/or additionally, the external surface may be adjacent to a surface of the apparatus 100. In some examples, the external surface may be manufactured such that the external surface matches that of the surface of the apparatus 100. For example, at least one of a roughness, patterning, smoothness, etc. of the external surface may match at least one of a roughness, patterning, smoothness, etc. of the surface of the apparatus 100. In some examples, the external surface and/or the surface of the apparatus 100 may be on at least one of the first side 1001, the second side 1002, the third side 1003, the fourth side 1004 and/or a fifth side of the apparatus 100. In some examples, the fifth side may be on an opposite side of the apparatus 100 as the second side 1002.

In some examples, the apparatus 100 may comprise a fan. The fan may comprise an impeller, a rotor and/or a runner (e.g., a rotating arrangement of vanes and/or blades). In some examples, the fan may be positioned on at least one of the first side 1001, the second side 1002, the third side 1003, the fourth side 1004 and/or the fifth side of the apparatus 100. The fan may be configured to produce airflow, such as to cool people near the fan. Alternatively and/or additionally, the apparatus 100 may comprise a conference calling device and/or a telephone. In some examples, the conference calling device and/or the telephone may be positioned on at least one of the first side 1001, the second side 1002, the third side 1003, the fourth side 1004 and/or the fifth side of the apparatus 100. Alternatively and/or additionally, the apparatus 100 may comprise a card holder (e.g., a compartment for holding cards, such as business cards, credit cards, etc.). In some examples, the card holder may be positioned on at least one of the first side 1001, the second side 1002, the third side 1003, the fourth side 1004 and/or the fifth side of the apparatus 100. Alternatively and/or additionally, the apparatus 100 may comprise a picture holder (e.g., a compartment for holding a picture, etc.). The picture may be visible when the picture is inside the picture holder. In some examples, the picture holder may be positioned on at least one of the first side 1001, the second side 1002, the third side 1003, the fourth side 1004 and/or the fifth side of the apparatus 100.

In some examples, the apparatus 100 may comprise a heater. For example, the heater may be positioned within the apparatus 100. The heater may be within a heater enclosure of the apparatus 100. Alternatively and/or additionally, the heater may be coupled to a sliding module within the heater enclosure. The sliding module may enable the heater to be pulled out of the apparatus 100 (such as drawn out horizontally using one or more drawer sliders). In some examples, the sliding module may be associated with a push to open configuration. For example, responsive to applying a pushing force to an external surface of the heater enclosure, the heater may be released and/or the sliding module may apply a force to push the heater and/or the external surface in a direction towards outside of the apparatus 100 (e.g., the force may be applied by a spring). In some examples, the external surface may be coupled to the sliding module. Alternatively and/or additionally, the external surface may correspond to a portion of the heater enclosure that is visible from outside the apparatus 100 when the heater is within the apparatus 100. The external surface may be coupled to the heater. Alternatively and/or additionally, the external surface may be adjacent to a surface of the apparatus 100. In some examples, the external surface may be manufactured such that the external surface matches that of the surface of the apparatus 100. For example, at least one of a roughness, patterning, smoothness, etc. of the external surface may match at least one of a roughness, patterning, smoothness, etc. of the surface of the apparatus 100. In some examples, the external surface and/or the surface of the apparatus 100 may be on at least one of the first side 1001, the second side 1002, the third side 1003, the fourth side 1004 and/or the fifth side of the apparatus 100. Alternatively and/or additionally, the heater may be exposed (and/or not positioned within the heater enclosure). For example, the heater may be positioned on top of the third side 1003 of the apparatus 100 (e.g., the third side 1003 may correspond to a top side of the apparatus 100). In some examples, the heater may be used to heat one or more objects placed on or near the heater. For example, a cup (e.g., a coffee mug) may be placed onto the heater and/or the heater may be configured to heat contents of the cup (e.g., coffee).

In some examples, the apparatus 100 may comprise a pair of scissors. For example, the pair of scissors may be positioned within the apparatus 100. The pair of scissors may be within a scissors enclosure of the apparatus 100. Alternatively and/or additionally, the pair of scissors and/or the scissors enclosure may be coupled to a sliding module. The sliding module may enable the pair of scissors to be pulled out of the apparatus 100 (such as drawn out horizontally using one or more drawer sliders). In some examples, the sliding module may be associated with a push to open configuration. For example, responsive to applying a pushing force to an external surface of the scissors enclosure, the pair of scissors may be released and/or the sliding module may apply a force to push the pair of scissors and/or the external surface in a direction towards outside of the apparatus 100 (e.g., the force may be applied by a spring). In some examples, the external surface may be coupled to the sliding module. Alternatively and/or additionally, the external surface may correspond to a portion of the scissors enclosure that is visible from outside the apparatus 100 when the pair of scissors is within the apparatus 100. Alternatively and/or additionally, the external surface may be coupled to the pair of scissors. Alternatively and/or additionally, the external surface may be adjacent to a surface of the apparatus 100. In some examples, the external surface may be manufactured such that the external surface matches that of the surface of the apparatus 100. For example, at least one of a roughness, patterning, smoothness, etc. of the external surface may match at least one of a roughness, patterning, smoothness, etc. of the surface of the apparatus 100. In some examples, the external surface and/or the surface of the apparatus 100 may be on at least one of the first side 1001, the second side 1002, the third side 1003, the fourth side 1004 and/or the fifth side of the apparatus 100. In some examples, the pair of scissors may be used for cutting materials, such as paper, cardboard, metal foil, cloth, rope and/or wire.

In some examples, the apparatus 100 may comprise a tape dispenser. For example, the tape dispenser may be positioned on at least one of the first side 1001, the second side 1002, the third side 1003, the fourth side 1004 and/or the fifth side of the apparatus 100. In some examples, the tape dispenser may be a mechanical tape dispenser (e.g., a manual tape dispenser). Alternatively and/or additionally, the tape dispenser may be an electrical tape dispenser (e.g., an automated tape dispenser).

In some examples, the electrical tape dispenser may dispense tape responsive to receiving a selection of a button (e.g., a physical button, a graphical selectable input, a projected selectable input, etc.) associated with the electrical tape dispenser. An amount of tape may be dispensed based upon one or more tape dispense settings. In some examples, the one or more tape dispense settings may be received and/or configured via at least one of the graphical user interface, the conversational interface, the voice interface, the projection interface, the control interface, etc. Alternatively and/or additionally, the amount of tape may be dispensed based upon a duration of time that the button is pressed (e.g., the button being pressed for one second or less may correspond to a first amount of tape, the button being pressed for 2 seconds may correspond to a second amount of tape greater than the first amount of tape, the button being pressed for 4 seconds may correspond to a third amount of tape greater than the second amount of tape, etc.).

Alternatively and/or additionally, the electrical tape dispenser may dispense tape responsive to receiving a command via at least one of the graphical user interface, the conversational interface, the voice interface, the projection interface, the control interface, etc. In some examples, an amount of tape may be dispensed based upon the one or more tape dispense settings. Alternatively and/or additionally, the amount of tape may be dispensed based upon the command (e.g., the command may be indicative of the amount of tape). In an example, the command may be indicative of 6 inches of tape (and/or a different length of tape) and/or the amount of tape may correspond to about 6 inches in length (and/or the different length of tape).

Alternatively and/or additionally, the command may be indicative of the tape being used for packaging. In an example where the apparatus 100 and/or the one or more components of the apparatus 100 are controlled via the voice interface and/or the conversational interface, a voice command “Dispense tape to package a box” may be received via the microphone. Alternatively and/or additionally, in an example where the apparatus 100 and/or the one or more components of the apparatus 100 are controlled via the graphical user interface, the control interface and/or the projection interface, a selection of a selectable input (e.g., a graphical selectable input and/or a projected selectable input) may be received, wherein the selectable input corresponds to tape for packaging an object (e.g., a box).

In some examples, the amount of tape may be determined based upon a size of the object and/or a weight of the object. Alternatively and/or additionally, a quantity of layers of tape for packaging the object (e.g., taping the object using a single layer of tape, two layers of tape, etc.) may be determined based upon the weight of the object. The amount of tape may be determined based upon the quantity of layers of tape and/or the size of the object. For example, the size of the object and/or the weight of the object may be received via at least one of the graphical user interface, the conversational interface, the voice interface, the projection interface, the control interface, etc. Alternatively and/or additionally, the apparatus 100 may activate a sensor (e.g., at least one of an optical sensor, a camera, a motion sensor, etc.) configured to detect the object and/or determine a size of the object. For example, the object may be detected using one or more object recognition techniques and/or the size of the object may be determined using one or more image processing techniques.

In some examples, the stapler device 102 may be configured to couple sheets of paper together by driving a staple through the sheets of paper at a point within the indentation 104. The stapler device 102 may comprise a magazine. The magazine may comprise a set of staples. Alternatively and/or additionally, the stapler device 102 may comprise a plurality of magazines. For example, each magazine of the plurality of magazines may comprise a set of staples of a type. For example, a first magazine of the plurality of magazines may comprise a set of staples of a first type of staple. Alternatively and/or additionally, a second magazine of the plurality of magazines may comprise a set of staples of a second type of staple. In some examples, a staple of the first type of staple may have a size, a thickness, a density, one or more properties, etc. different than a staple of the second type of staple. In some examples, a staple of the first type of staple may be configured for a first range of quantities of sheets of paper and/or a staple of the second type of staple may be configured for a second range of quantities of sheets of paper. In an example, a staple of the first type of staple may be configured for stapling between 2 and 20 sheets of paper together and/or a staple of the second type of staple may be configured for stapling between 21 and 100 sheets of paper together.

In some examples, the stapler device 102 may perform a stapling operation (e.g., couple sheets of paper together by driving a staple through the sheets of paper at a point within the indentation 104) responsive to receiving a selection of a button (e.g., a physical button, a graphical selectable input, a projected selectable input, etc.) associated with the stapler device 102. In some examples, a level of force for performing the stapling operation (e.g., a level of driving force used for driving the staple through the sheets of paper) may be applied based upon one or more stapling settings. In some examples, the one or more stapling settings may be received and/or configured via at least one of the graphical user interface, the conversational interface, the voice interface, the projection interface, the control interface, etc.

Alternatively and/or additionally, the stapler device 102 may perform a stapling operation responsive to receiving a command via at least one of the graphical user interface, the conversational interface, the voice interface, the projection interface, the control interface, etc. In some examples, a level of force for performing the stapling operation may be applied based upon based upon the one or more stapling settings. For example, a stapling setting of the one or more stapling settings may correspond to a first level of force of a plurality of levels of force. In an example, the plurality of levels of force may comprise a low level of force, a medium level of force (higher than the low level of force), a high level of force (higher than the medium level of force) and/or a different level of force. In an example, the stapling setting may correspond to the low level of force and/or the low level of force may be applied for performing the stapling operation. Alternatively and/or additionally, the level of force for performing the stapling operation may be applied based upon the command (e.g., the command may be indicative of the level of force for performing the stapling operation).

In some examples, the level of force for performing the stapling operation may be applied based upon a quantity of sheets of paper to staple together. In some examples, the low level of force of the plurality of levels of force may be associated with the first range of quantities of sheets of paper, the medium level of force of the plurality of levels of force may be associated with the second range of quantities of sheets of paper and/or the high level of force of the plurality of levels of force may be associated with a third range of quantities of sheets of paper. In some examples, the quantity of sheets of paper and/or a range of quantities of sheets of paper may be determined based upon the one or more stapling settings (e.g., the one or more stapling settings may be indicative of the quantity of sheets of paper and/or the range of quantities of sheets of paper). Alternatively and/or additionally, the quantity of sheets of paper and/or the range of quantities of sheets of paper may be determined based upon the command (e.g., the command may be indicative of the quantity of sheets of paper and/or the range of quantities of sheets of paper).

In some examples, the quantity of sheets of paper and/or the range of quantities of sheets of paper may be determined using a sensor configured to determine the quantity of sheets of paper and/or the range of quantities of sheets of paper. For example, the sensor may be positioned within the indentation 104. The sensor may comprise at least one of an optical sensor, a camera, etc. The quantity of sheets of paper and/or the range of quantities of sheets of paper may be determined based upon a signal received from the sensor (e.g., one or more processing techniques, such as image processing techniques, may be applied to the signal to determine the quantity of sheets of paper and/or the range of quantities of sheets of paper). Alternatively and/or additionally, the sensor may comprise one or more sensors configured to detect touch. The quantity of sheets of paper and/or the range of quantities of sheets of paper may be determined based upon one or more signals received from the one or more sensors. A signal of the one or more signals may be indicative of whether a sensor of the one or more sensors is touched by one or more sheets of paper. A thickness of a set of sheets of paper within the indentation 104 may be determined based upon the one or more signals. The quantity of sheets of paper and/or the range of quantities of sheets of paper may be determined based upon the thickness of the set of sheets of paper within the indentation 104. Alternatively and/or additionally, the sensor may comprise a proximity sensor configured to detect a first distance between the sensor and the set of sheets of paper within the indentation 104. In an example, the proximity sensor may be above the set of sheets of paper and/or the proximity sensor may be coupled to a top surface of the indentation 104. For example, the first distance may correspond to a distance between the top surface of the indentation 104 and the set of sheets of paper. In some examples, the thickness of the set of sheets of paper may be determined based upon the first distance and/or a second distance D1 (illustrated in FIG. 1C) between the top surface of the indentation 104 and a bottom surface of the indentation 104. For example, the thickness of the set of sheets of paper may be determined by performing one or more operations (e.g., mathematical operations) using the first distance and/or the second distance D1 (e.g., the thickness may be approximately equal to a difference between the second distance D1 and the first distance).

In an example where the stapler device comprises the plurality of magazines and/or a plurality of types of staples, a magazine of the plurality of magazines and/or a type of staple may be selected for performing the stapling operation based upon the one or more stapling settings. For example, a stapling setting of the one or more stapling settings may correspond to a magazine of the plurality of magazines and/or a type of staple of the first type of staple or the second type of staple. Alternatively and/or additionally, the magazine and/or the type of staple for performing the stapling operation may be selected based upon the command (e.g., the command may be indicative of the magazine and/or the type of staple). Alternatively and/or additionally, the magazine and/or the type of staple may be selected based upon the quantity of sheets of paper, the range of quantities of sheets of paper quantity and/or the thickness of the set of sheets of paper. In an example, the first magazine and/or the first type of staple may be selected responsive to determining that the thickness of the set of sheets of paper is associated with the first range of quantities of sheets of paper. Alternatively and/or additionally, responsive to determining that the thickness of the set of sheets of paper is associated with the first range of quantities of sheets of paper, the stapler device 102 may drive a staple of the first type of staple (and/or the first magazine) through the set of sheets of paper to couple the set of sheets of paper together.

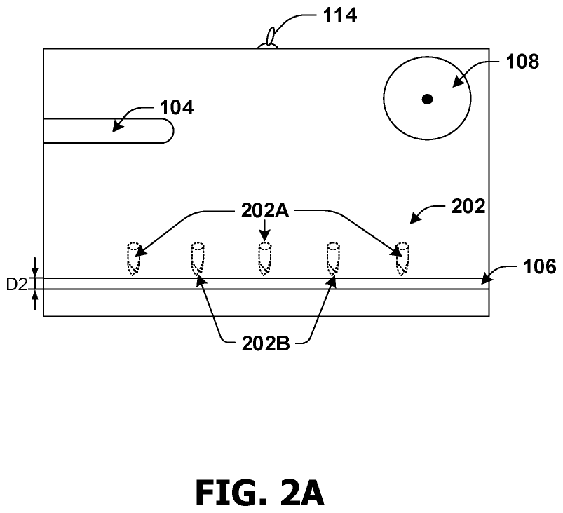

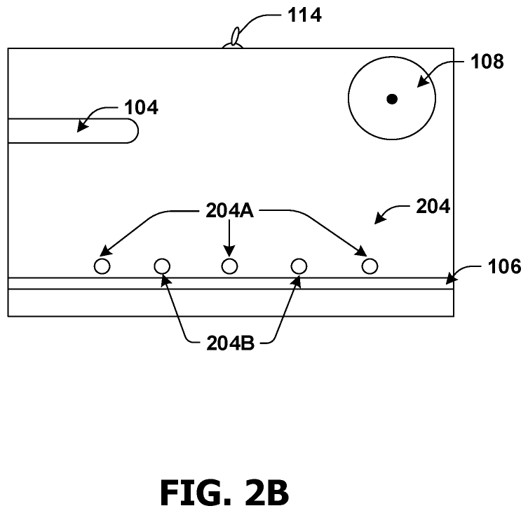

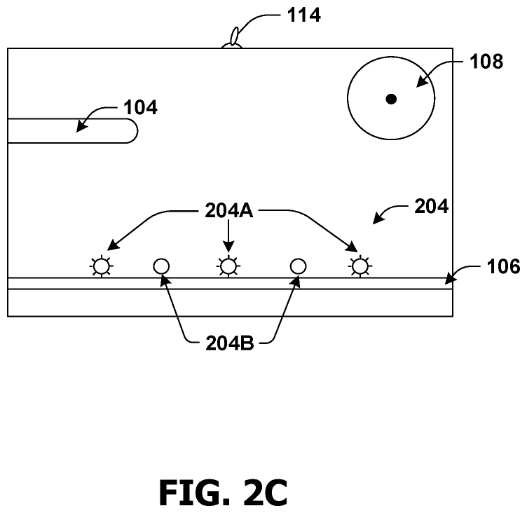

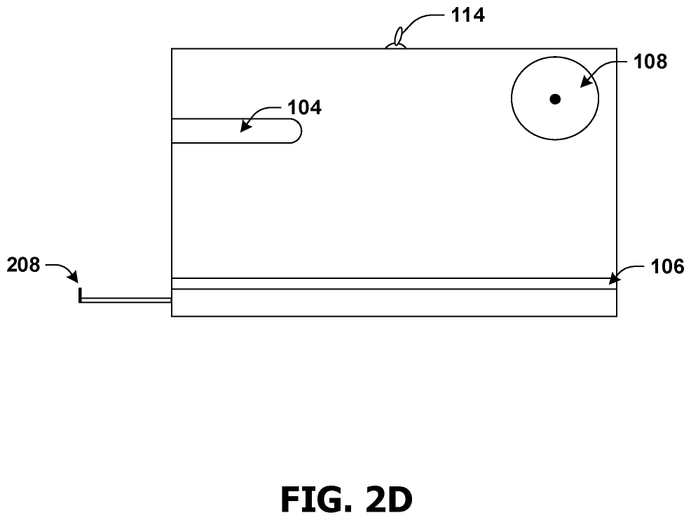

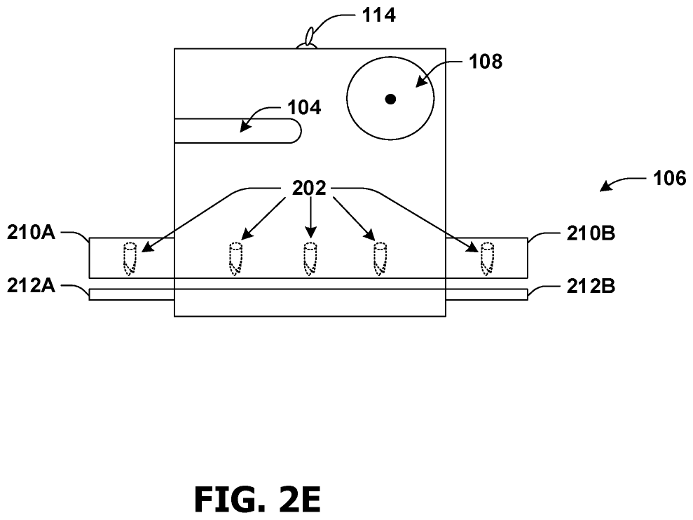

FIGS. 2A-2E present embodiments of the hole puncher device 106. FIG. 2A illustrates a plurality of punches 202 of the hole puncher device 106. The plurality of punches 202 are illustrated using dotted lines to signify that the plurality of punches 202 are within the apparatus 100, and may not actually be visible from outside of the apparatus 100. In some examples, the hole puncher device 106 may be configured to punch one or more holes in one or more sheets of paper using one or more punches of the plurality of punches 202. In some examples, a punch of the plurality of punches 202 may be used for producing a hole within a sheet of paper. For example, a punch of the plurality of punches 202 may comprise at least one of a bladed cylinder, a hollowed drill, etc. In some examples, one or more holes may be punched in one or more sheets of paper by driving one or more punches of the plurality of punches 202 through one or more points of a second indentation of the hole puncher device 106 when a portion of the one or more sheets of paper is within the second indentation.

In some examples, the hole puncher device 106 may perform a hole punch operation (e.g., punch one or more holes in one or more sheets of paper) responsive to receiving a selection of a button (e.g., a physical button, a graphical selectable input, a projected selectable input, etc.) associated with the hole puncher device 106. In some examples, a level of force for performing the hole punch operation (e.g., a level of driving force used for driving one or more punches of the plurality of punches 202 through the one or more sheets of paper) may be applied based upon one or more hole punch settings. In some examples, the one or more hole punch settings may be received and/or configured via at least one of the graphical user interface, the conversational interface, the voice interface, the projection interface, the control interface, etc.

Alternatively and/or additionally, the hole puncher device 106 may perform a hole punch operation responsive to receiving a command via at least one of the graphical user interface, the conversational interface, the voice interface, the projection interface, the control interface, etc. In some examples, a level of force for performing the hole punch operation may be applied based upon based upon the one or more hole punch settings. For example, a hole punch setting of the one or more hole punch settings may correspond to a first level of force of a plurality of levels of force. In an example, the plurality of levels of force may comprise a low level of force, a medium level of force (higher than the low level of force), a high level of force (higher than the medium level of force) and/or a different level of force. In an example, the hole punch setting may correspond to the low level of force and/or the low level of force may be applied for performing the stapling operation. Alternatively and/or additionally, the level of force for performing the hole punch operation may be applied based upon the command (e.g., the command may be indicative of the level of force for performing the hole punch operation).

In some examples, the level of force for performing the hole punch may be applied based upon a quantity of sheets of paper. In some examples, the low level of force of the plurality of levels of force may be associated with a first range of quantities of sheets of paper, the medium level of force of the plurality of levels of force may be associated with a second range of quantities of sheets of paper (higher than the first range of quantities of sheets of paper) and/or the high level of force of the plurality of levels of force may be associated with a third range of quantities of sheets of paper (higher than the second range of quantities of sheets of paper). In some examples, the quantity of sheets of paper and/or a range of quantities of sheets of paper may be determined based upon the one or more hole punch settings (e.g., the one or more hole punch settings may be indicative of the quantity of sheets of paper and/or the range of quantities of sheets of paper). Alternatively and/or additionally, the quantity of sheets of paper and/or the range of quantities of sheets of paper may be determined based upon the command (e.g., the command may be indicative of the quantity of sheets of paper and/or the range of quantities of sheets of paper).

In some examples, the quantity of sheets of paper and/or the range of quantities of sheets of paper may be determined using a sensor configured to determine the quantity of sheets of paper and/or the range of quantities of sheets of paper. For example, the sensor may be positioned within the second indentation of the hole puncher device 106. The sensor may comprise at least one of an optical sensor, a camera, etc. The quantity of sheets of paper and/or the range of quantities of sheets of paper may be determined based upon a signal received from the sensor (e.g., one or more processing techniques, such as image processing techniques, may be applied to the signal to determine the quantity of sheets of paper and/or the range of quantities of sheets of paper). Alternatively and/or additionally, the sensor may comprise one or more sensors configured to detect touch. The quantity of sheets of paper and/or the range of quantities of sheets of paper may be determined based upon one or more signals received from the one or more sensors. A signal of the one or more signals may be indicative of whether a sensor of the one or more sensors is touched by one or more sheets of paper. A thickness of a set of sheets of paper (e.g., a set of one or more sheets of paper) within the second indentation may be determined based upon the one or more signals. The quantity of sheets of paper and/or the range of quantities of sheets of paper may be determined based upon the thickness of the set of sheets of paper within the second indentation. Alternatively and/or additionally, the sensor may comprise a proximity sensor configured to detect a third distance between the sensor and the set of sheets of paper within the second indentation. In an example, the proximity sensor may be above the set of sheets of paper and/or the proximity sensor may be coupled to a top surface of the second indentation. For example, the third distance may correspond to a distance between the top surface of the second indentation and the set of sheets of paper. In some examples, the thickness of the set of sheets of paper may be determined based upon the third distance and/or a fourth distance D2 (illustrated in FIG. 2A) between the top surface of the second indentation and a bottom surface of the second indentation. For example, the thickness of the set of sheets of paper may be determined by performing one or more operations (e.g., mathematical operations) using the third distance and/or the fourth distance D2 (e.g., the thickness may be approximately equal to a difference between the fourth distance D2 and the third distance).

In some examples, the fourth distance D2 between the top surface of the second indentation and the bottom surface of the second indentation may be based upon a threshold thickness of sheets of paper and/or a threshold quantity of sheets of paper. For example, the threshold thickness of sheets of paper may correspond to a maximum thickness of a set of sheets of paper that the hole puncher device 106 may punch holes through (and/or a maximum thickness of a set of sheets of paper that the hole puncher device 106 is rated to punch holes through). Alternatively and/or additionally, the threshold quantity of sheets of paper may correspond to a maximum quantity of sheets of paper that the hole puncher device 106 may punch holes through (and/or a maximum quantity of sheets of paper that the hole puncher device 106 is rated to punch holes through). In some examples, the fourth distance D2 may be configured such that a set of sheets of paper with a thickness exceeding the threshold thickness of sheets of paper may not be positioned within the second indentation (e.g., the set of sheets of paper may not fit within the second indentation). Alternatively and/or additionally, the fourth distance D2 may be configured such that a set of sheets of paper with a quantity of sheets exceeding the threshold quantity of sheets of paper may not be positioned within the second indentation (e.g., the set of sheets of paper may not fit within the second indentation). In an example, the fourth distance D2 may be less than and/or approximately equal to the threshold thickness of sheets of paper.

In some examples, the plurality of punches 202 may comprise a plurality of sets of punches. In some examples, a set of punches of the plurality of punches 202 may be associated with a hole configuration of a plurality of hole configurations. A hole configuration of the plurality of hole configurations may be associated with a hole punching standard (e.g., dimensions and/or locations of holes punched in paper). In an example, one or more sheets of paper hole punched in association with a first hole configuration of the plurality of hole configurations may be collected in a first type of binder and/or folder (the first type of binder and/or folder may be associated with a hole punching standard associated with the first hole configuration). One or more sheets of paper hole punched in association with a second hole configuration of the plurality of hole configurations may be collected in a second type of binder and/or folder (the second type of binder and/or folder may be associated with a hole punching standard associated with the second hole configuration).

In an example, the first hole configuration of the plurality of hole configurations may correspond to a three-hole hole punching standard (and/or a different hole punching standard), the second hole configuration of the plurality of hole configurations may correspond to a two-hole hole punching standard (and/or a different hole punching standard), a third hole configuration of the plurality of hole configurations may correspond to a four-hole hole punching standard (and/or a different hole punching standard), a fourth hole configuration of the plurality of hole configurations may correspond to International Organization for Standardization (ISO) 838 hole punching standard (and/or a different hole punching standard), a fifth hole configuration of the plurality of hole configurations may correspond to ISO 888 hole punching standard (and/or a different hole punching standard), etc.

In some examples, the plurality of punches 202 may comprise a first set of punches 202A and/or a second set of punches 202B. In some examples, the first set of punches 202A may be associated with the first hole configuration. Alternatively and/or additionally, the second set of punches 202B may be associated with the second hole configuration. In some examples, a first set of sheets of paper (e.g., a first set of one or more sheets of paper) may be hole punched using the first set of punches 202A to produce a first set of holes in the one or more first sheets of paper based upon the first hole configuration (e.g., merely the first set of punches 202A of the plurality of punches 202 may be forced downwards and/or driven through the first set of sheets of paper to produce the first set of holes in the first set of sheets of paper). Alternatively and/or additionally, a second set of sheets of paper (e.g., a second set of one or more sheets of paper) may be hole punched using the second set of punches 202B to produce a second set of holes in the one or more second sheets of paper based upon the second hole configuration (e.g., merely the second set of punches 202B of the plurality of punches 202 may be forced downwards and/or driven through the second set of sheets of paper to produce the second set of holes in the second set of sheets of paper).

In some examples, a hole configuration of the plurality of hole configurations may be determined based upon the one or more hole punch settings. For example, a hole configuration setting of the one or more hole punch settings may correspond to a hole configuration of the plurality of hole configurations. In an example, the first set of punches 202A may be used to hole punch the first set of sheets of paper responsive to a determination that the hole configuration setting of the one or more hole punch settings corresponds to the first hole configuration. Alternatively and/or additionally, a hole configuration of the plurality of hole configurations may be determined based upon a command received via at least one of the graphical user interface, the conversational interface, the voice interface, the projection interface, the control interface, etc. For example, the command may be indicative of a hole configuration of the plurality of hole configurations. In an example, the first set of punches 202A may be used to hole punch the first set of sheets of paper responsive to a determination that a command to hole punch the first set of sheets of paper corresponds to the first hole configuration. In an example where the command is received via the voice interface and/or the conversational interface, the command may correspond to a person saying “hole punch the paper using the three-hole standard”.

In some examples, one or more punches for performing a hole punch operation may be determined using one or more sensors of the hole puncher device 106. In some examples, a sensor of the one or more sensors may be within the second indentation of the hole puncher device 106. The one or more sensors may be configured to determine one or more areas within the second indentation that are occupied by a set of sheets of paper (e.g., a set of one or more sheets). In some examples, the one or more sensors may comprise at least one of one or more optical sensors, one or more cameras, etc. The one or more areas occupied by the set of sheets of paper may be determined based upon one or more signals received from the one or more sensors (e.g., one or more processing techniques, such as image processing techniques, may be applied to the one or more signals to determine the one or more areas occupied by the set of sheets of paper).

Alternatively and/or additionally, the one or more sensors may comprise one or more touch sensors configured to detect touch. The one or more areas occupied by the set of sheets of paper may be determined based upon one or more signals received from the one or more touch sensors. A signal of the one or more signals may be indicative of whether a sensor of the one or more touch sensors is touched by a sheet of paper. The one or more areas occupied by the set of sheets of paper may be determined based upon the one or more signals.

In some examples, the one or more punches for performing the hole punch operation may be determined based upon the one or more areas occupied by the set of sheets of paper. For example, the one or more punches may correspond to the one or more areas occupied by the set of sheets of paper. In an example, it may be determined that the one or more areas occupied by the set of sheets of paper are associated with a first punch and/or a second punch of the plurality of punches 202. The hole punch operation may be performed using the first punch and/or the second punch (e.g., merely the first punch and/or the second punch of the plurality of punches 202 may be forced downwards and/or driven through the set of sheets of paper). In another example, it may be determined that the one or more areas occupied by the set of sheets of paper are associated with merely a single punch of the plurality of punches 202 (e.g., the set of sheets of paper may comprise one or more index cards and/or small sheets of paper that cover an area associated with merely the single punch of the plurality of punches 202). The hole punch operation may be performed using the single punch (e.g., merely the single punch of the plurality of punches 202 may be forced downwards and/or driven through the set of sheets of paper).

FIG. 2B illustrates an embodiment of the apparatus 100 comprising a plurality of lights 204 associated with the plurality of punches 202. In some examples, the plurality of lights 204 may comprise a plurality of sets of lights associated with the plurality of sets of punches. In an example, a first set of lights 204A of the plurality of lights 204 may be associated with the first set of punches 202A of the plurality of punches 202. Alternatively and/or additionally, a second set of lights 204B of the plurality of lights 204 may be associated with the second set of punches 202B of the plurality of punches 202.

In some examples, a set of lights of the plurality of sets of lights, associated with a set of punches of the plurality of sets of hole punches, may be activated by a light controller responsive to a determination that the hole configuration setting of the one or more hole punch settings corresponds to a hole configuration associated with the set of punches. In an example, the first set of lights 204A may be activated by the light controller responsive to a determination that the hole configuration setting of the one or more hole punch settings corresponds to the first hole configuration associated with the first set of punches 202A. Alternatively and/or additionally, the second set of lights 204B may be activated by the light controller responsive to a determination that the hole configuration setting of the one or more hole punch settings corresponds to the second hole configuration associated with the second set of punches 202B.

In some examples, a set of lights of the plurality of sets of lights may be activated by the light controller responsive to receiving a command via at least one of the graphical user interface, the conversational interface, the voice interface, the projection interface, the control interface, etc. In some examples, the set of lights may be activated prior to performing a hole punch operation associated with the command. In some examples, the set of lights may be associated with a set of punches associated with a hole configuration associated with the hole punch operation. For example, the hole configuration and/or the set of punches may be determined based upon the one or more hole punch settings and/or the command. In some examples, responsive to activation of the set of lights, the hole punch operation may be performed after passage of a cancel period of time. For example, during the cancel period of time, the hole punch operation may be cancelled. The hole punch operation may be cancelled responsive to receiving a command associated with cancelling the hole punch operation. Alternatively and/or additionally, the hole punch operation may be cancelled responsive to receiving a selection of a button (e.g., a physical button, a graphical selectable input, a projected selectable input, etc.) associated with the hole puncher device 106. It may be appreciated that activating the set of lights and performing the hole punch operation after passage of the cancel period of time before may provide a person with an opportunity to cancel the hole punch operation in a scenario where the set of lights is indicative of a hole configuration that is undesired by the person.

FIG. 2C illustrates an exemplary scenario where the hole configuration setting of the one or more hole punch settings corresponds to the first hole configuration associated with the first set of punches 202A. For example, the first set of lights 204A may be activated based upon the hole configuration setting corresponding to the first hole configuration.

In some examples, rather than (and/or in addition to) using the plurality of lights 204 to indicate a hole configuration associated with the hole configuration setting, information indicative of the hole configuration may be presented via at least one of the graphical user interface, the conversational interface, the voice interface, the projection interface, the control interface, etc.

FIG. 2D illustrates an embodiment of the hole puncher device 106 comprising a guide 208. The guide 208 may be used for aligning a set of sheets of paper (e.g., a set of one or more sheets of paper). The set of sheets may be positioned by lining up the set of sheets of paper with the guide 208. For example, by lining up the set of sheets of paper with the guide 208, the hole puncher device 106 may perform a hole punch operation to punch one or more holes in the set of sheets of paper correctly (e.g., correctly punching the one or more holes in the set of sheets of paper may correspond to punching the one or more holes in the set of sheets in accordance with a hole configuration of the plurality of hole configurations).

FIG. 2E illustrates an embodiment of the hole puncher device 106, where one or more punches of the plurality of punches 202 are comprised within one or more first arms 210. In some examples, the one or more first arms 210 may comprise a first arm 210A and/or a second arm 210B. In an example, the first arm 210A may comprise one or more first punches of the plurality of punches 202. In some examples, the first arm 210A may comprise machinery configured to force the one or more first punches downwards and/or drive the one or more first punches through a set of sheets of paper (responsive to receiving a command to perform a hole punch operation, for example). Alternatively and/or additionally, the second arm 210B may comprise one or more second punches of the plurality of punches 202. In some examples, the second arm 210B may comprise machinery configured to force the one or more second punches downwards and/or drive the one or more second punches through the set of sheets of paper (responsive to receiving a command to perform a hole punch operation, for example).

In some examples, the hole puncher device 106 may comprise one or more second arms 212. The one or more second arms 212 may comprise a third arm 212A and/or a fourth arm 212B. In some examples, the one or more second arms 212 may act as support for the set of sheets of paper. In some examples, the one or more first arms 210 and/or the one or more second arms 212 may be extendable and/or retractable (e.g., one or more first arms 210 may be pulled outside of the apparatus 100 and/or the one or more first arms may be pushed inside of the apparatus 100). It may be appreciated that including one or more punches of the plurality of punches 202 in the one or more first arms 210 may result in the apparatus 100 being smaller and/or more portable than in an embodiment where the one or more punches are not within the one or more first arms 210.

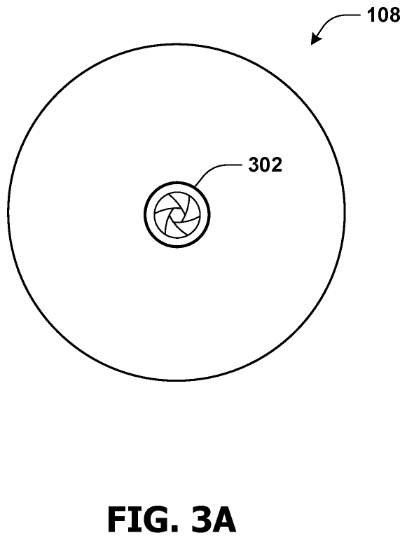

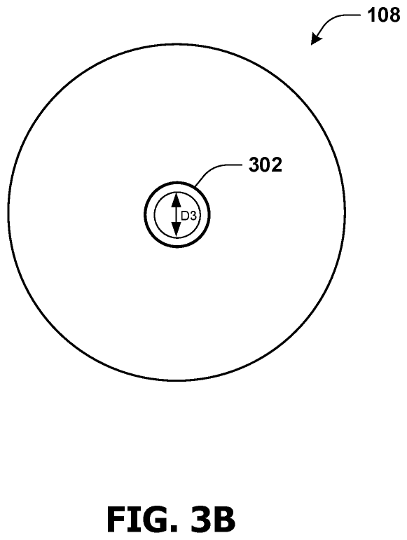

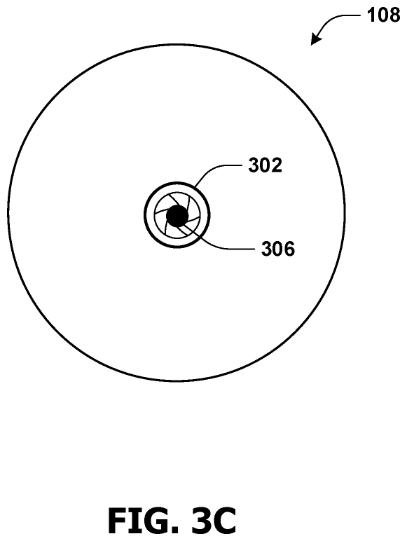

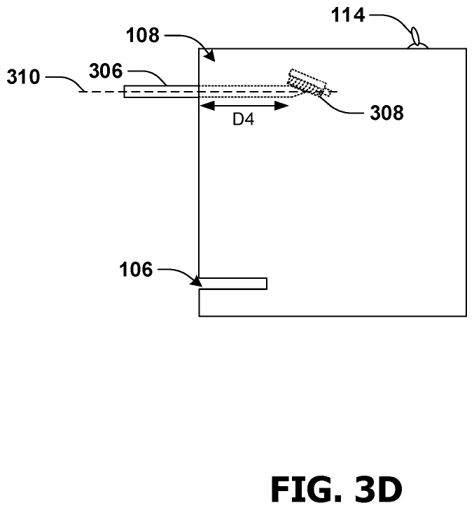

FIGS. 3A-3D present embodiments of the sharpener device 108. In some examples, the sharpener device 108 may comprise a shutter device 302. FIG. 3A illustrates an embodiment of the sharpener device 108 comprising the shutter device 302. In some examples, the shutter device 302 may be coupled to an opening of the sharpener device 108. In some examples, the shutter device 302 may be in a closed state. The closed state of the shutter device 302 may correspond a state of the shutter device 302 where the shutter device 302 encloses at least a portion of the opening of the sharpener device 108. The shutter device 302 may enclose at least a portion of the opening of the sharpener device 108 by covering the opening using one or more shutter objects (e.g., one or more leaf blades, shutter blades of a diaphragm such as an iris diaphragm, etc.). FIG. 3A illustrates the shutter device 302 in the closed state.

FIG. 3B illustrates an embodiment of the sharpener device 108, where the shutter device 302 is in an open state. In some examples, the open state of the shutter device 302 may correspond to a state of the shutter device 302 where the shutter device 302 does not enclose the opening of the sharpener device 108. For example, the one or more shutter objects may not cover the opening in the open state of the shutter device 302.

In some examples, the shutter device 302 may enter the open state (from the closed state) responsive to receiving a selection of a button (e.g., a physical button, a graphical selectable input, a projected selectable input, etc.) associated with the sharpener device 108. Alternatively and/or additionally, the shutter device 302 may enter the open state (from the closed state) responsive to receiving a command via at least one of the graphical user interface, the conversational interface, the voice interface, the projection interface, the control interface, etc. In some examples, the shutter device 302 may enter the open state (from the closed state) based upon the command comprising a password (e.g., a sequence of letters, numbers and/or symbols) associated with the open state of the shutter device 302. In an example where the command is associated with the conversational interface, audio representative of the password (e.g., audio comprising speech of a person stating the password) may be detected via the microphone. The audio may be interpreted as the command to enter the open state.

It may be appreciated that the shutter device 302 entering the open state responsive to receiving the command (and/or responsive to the command comprising the password) may result in safer operation of the sharpener device 108 as a result of preventing a person (e.g., a child) from placing a finger within the opening of the sharpener device 108 (e.g., the person may not know the password and/or how to input the command via at least one of the graphical user interface, the conversational interface, the voice interface, the projection interface, the control interface, etc.).

In some examples, the sharpener device 108 may be configured for sharpening pencils having sizes of a first range of sizes. The first range of sizes may range from a first size (e.g., a first pencil width and/or a first pencil diameter) to a second size (e.g., a second pencil width and/or a second pencil diameter). In an example, the first size may correspond to 6 millimeters (mm) and/or a different size (e.g., a pencil having a width and/or a diameter corresponding to 6 mm and/or a different size). In an example, the second size may correspond to 12 mm and/or a different size (e.g., a pencil having a width and/or a diameter corresponding to 12 mm and/or a different size).

In some examples, an opening size of the opening of the sharpener device 108 may be larger than and/or approximately equal to the second size such that pencils having a size of the first range of sizes fit inside the opening of the sharpener device 108. In an example, the opening size may correspond to a fifth distance D3 (illustrated in FIG. 3B) between a first part of the opening and a second part of the opening, where the second part of the opening opposes the first part of the opening. The fifth distance D3 may correspond to a diameter of the opening of the sharpener device 108. In some examples, the fifth distance D3 may be greater than and/or approximately equal to the second size. In an example where the second size is 12 mm, the fifth distance D3 may be greater than 12 mm (e.g., 13 mm) and/or approximately equal to 12 mm.

FIG. 3C illustrates an embodiment of the sharpener device 108, where the shutter device 302 is in an enclosing state. In some examples, the enclosing state of the shutter device 302 may correspond to a state of the shutter device 302 where the shutter device 302 encloses a portion of a first pencil 306. For example, the shutter device 302 may move the one or more shutter objects towards a center of the shutter device 302 to enclose the portion of the first pencil 306. The shutter device 302 may enclose the portion of the first pencil 306 to maintain the first pencil 306 in a position. The position may correspond to the center of shutter device 302 (and/or a center of the opening of the sharpener device 108). In some examples, by maintaining the first pencil 306 in the position, an orientation of the first pencil 306 may be maintained along a center axis 310 (illustrated in FIG. 3D) such that the first pencil 306 is not tilted and/or such that the sharpener device 108 sharpens the first pencil 306 evenly and/or in a centered manner. In some examples, the center axis 310 is perpendicular to the first side 1001 of the apparatus 100.

In some examples, the shutter device 302 may enter the enclosing state responsive to receiving a selection of a button (e.g., a physical button, a graphical selectable input, a projected selectable input, etc.) associated with the sharpener device 108. Alternatively and/or additionally, the shutter device 302 may enter the enclosing state responsive to receiving a command via at least one of the graphical user interface, the conversational interface, the voice interface, the projection interface, the control interface, etc. Alternatively and/or additionally, the shutter device 302 may enter the enclosing state responsive to insertion of the first pencil 306 into the sharpener device 108. For example, the shutter device 302 may enclose the portion of the first pencil 306 responsive to insertion of the first pencil 306 into the sharpener device 108. In an example, the sharpener device 108 may comprise one or more sensors (e.g., at least one of one or more touch sensors, one or more proximity sensors, etc.) configured to detect insertion of the first pencil 306 into the sharpener device 108 and/or into the opening of the sharpener device 108. Responsive to receiving a signal from the one or more sensors indicative of the first pencil 306 being inserted into the sharpener device 108, the shutter device 302 may enter the enclosing state and/or the shutter device 302 may enclose the portion of the first pencil 306 to maintain the first pencil 306 in the position.

FIG. 3D illustrates the first pencil 306 within the sharpener device 108. FIG. 3D shows the fifth side of the apparatus 100. In FIG. 3D, a first portion of the first pencil 306 is outside the sharpener device 108 and/or a second portion of the first pencil 306 is within the sharpener device 108 (the second portion is illustrated using dotted lines to signify that the second portion is within the sharpener device 108, and may not actually be visible from outside of the apparatus 100). Alternatively and/or additionally, the sharpener device 108 may comprise a cutting module 308 (the cutting module 308 is illustrated using dotted lines to signify that the cutting module 308 is within the sharpener device 108, and may not actually be visible from outside of the apparatus 100).

The cutting module 308 may be used for sharpening the first pencil 306. The cutting module 308 may comprise one or more blades and/or one or more cutters configured to sharpen the first pencil 306. In some examples, the cutting module 308 may comprise one or more helical blades and/or one or more helical cutters configured to rotate around the first pencil 306 to sharpen the first pencil 306. For example, the cutting module 308 may comprise a motor configured to drive the one or more blades and/or the one or more cutters to sharpen the first pencil 306.

In some examples, the cutting module 308 may sharpen the first pencil 306 responsive to receiving a selection of a button (e.g., a physical button, a graphical selectable input, a projected selectable input, etc.) associated with the sharpener device 108. Alternatively and/or additionally, the cutting module 308 may sharpen the first pencil 306 responsive to receiving a command via at least one of the graphical user interface, the conversational interface, the voice interface, the projection interface, the control interface, etc. Alternatively and/or additionally, the cutting module 308 may sharpen the first pencil 306 responsive to insertion of the first pencil 306 into the sharpener device 108. Alternatively and/or additionally, the cutting module 308 may sharpen the first pencil 306 responsive to the first pencil 306 contacting the cutting module 308. For example, the cutting module 308 may comprise one or more sensors (e.g., at least one of one or more touch sensors, one or more proximity sensors, etc.) configured to detect contact of the first pencil 306 with the cutting module 308. Responsive to receiving a signal from the one or more sensors indicative of the first pencil 306 contacting the cutting module 308, the cutting module 308 may sharpen the first pencil 306.

In some examples, a sixth distance D4 between the cutting module 308 and the opening of the sharpener device 108 may be greater than a first length associated with a finger. For example, the first length may correspond to a length of a finger that may fit into the opening of the sharpener device 108, such as such as a finger (e.g., a pinky finger and/or a different finger) of a child. It may be appreciated that the sixth distance D4 being greater than the first length may result in safer operation of the sharpener device 108 as a result of preventing a finger of a person (e.g., a child) from reaching the cutting module 308 through the opening of the sharpener device 108.

In some examples, the sharpener device 108 and/or the cutting module 308 may sharpen the first pencil 306 to a level of sharpness of a plurality of levels of sharpness. In an example, the plurality of levels of sharpness may comprise a first level of sharpness (e.g., very blunt), a second level of sharpness (e.g., blunt) associated with a higher sharpness than the first level of sharpness, a third level of sharpness (e.g., sharp) associated with a higher sharpness than the second level of sharpness, a fourth level of sharpness (e.g., very sharp) associated with a higher sharpness than the third level of sharpness, etc. In some examples, the level of sharpness may be determined based upon a sharpness setting associated with the sharpener device 108. For example, the sharpness setting may be indicative of the level of sharpness. In some examples, the sharpness setting may be received and/or configured via at least one of the graphical user interface, the conversational interface, the voice interface, the projection interface, the control interface, etc. Alternatively and/or additionally, the level of sharpness may be determined based upon the command (e.g., the command may be indicative of the level of sharpness for sharpening the pencil).

In some examples, one or more properties associated with the sharpener device 108 may be configured based upon the level of sharpness. For example, the one or more properties may correspond to a positioning of the cutting module 308, a tilt angle associated with the cutting module 308 and/or operation of the cutting module 308 (e.g., the operation of the cutting module 308 may correspond to at least one of of a speed of rotation of the cutting module 308, a rotational force applied to the cutting module 308 by the motor of the cutting module 308, etc.). For example, the first level of sharpness may be associated with one or more first properties (e.g., a first positioning of the cutting module 308, a first tilt angle associated with the cutting module 308 and/or first operation of the cutting module 308) and/or the first level of sharpness may be associated with one or more second properties (e.g., a second positioning of the cutting module 308, a second tilt angle associated with the cutting module 308 and/or second operation of the cutting module 308). In an example, where the sharpener device 108 and/or the cutting module 308 sharpen the first pencil 306 to the first level of sharpness, the sharpener device 108 and/or the cutting module 308 may sharpen the first pencil 306 using the first positioning of the cutting module 308, a first tilt angle associated with the cutting module 308 and/or the first operation of the cutting module 308.

FIGS. 4A-4D present embodiments of the vacuum device 112 and/or the tray 420. FIG. 4A illustrates an embodiment of the vacuum device 112. In some examples, the vacuum device 112 may be detachable. For example, the vacuum device 112 may be detached from the apparatus 100. In some examples, the vacuum device 112 may comprise one or more first terminals. The one or more first terminals may be connected to one or more second terminals 402 on the apparatus 100 when the vacuum device 112 is attached to the apparatus 100. In some examples, the vacuum device 112 may be electrically powered by electricity received via the connection between the one or more second terminals 402 and the one or more first terminals of the vacuum device 112.

In some examples, the vacuum device 112 may comprise a fan module 406, a filter 404, a collecting space 412 and/or an opening 408. The fan module 406 and the filter 404 are illustrated using dotted lines to signify that the fan module 406 and the filter 404 are within the vacuum device 112, and may not actually be visible from outside of the vacuum device 112.

In some examples, the vacuum device 112 may be configured to apply suction to conduct material from within the tray 420 to the collecting space 412 within the vacuum device 112. The material may comprise shavings (from the sharpener device 108) and/or chips (from the hole puncher device 106). In some examples, the vacuum device 112 may apply suction responsive to activation of the switch 114. Alternatively and/or additionally, the vacuum device 112 may apply suction responsive to receiving a selection of a button (e.g., a physical button, a graphical selectable input, a projected selectable input, etc.) associated with the vacuum device 112. Alternatively and/or additionally, the vacuum device 112 may apply suction responsive to receiving a command via at least one of the graphical user interface, the conversational interface, the voice interface, the projection interface, the control interface, etc. In some examples, the vacuum device 112 may apply suction by activating the fan module 406. Material may be conducted into the collecting space 412. The filter 404 may mitigate (and/or prevent) material flowing into the fan module 406.

In some examples, the vacuum device 112 may be attached to the apparatus 100 using a push to detach mechanism. For example, responsive to applying a pushing force (e.g., a downwards pushing force) on the vacuum device 112, the vacuum device 112 may be released and/or the push to detach mechanism may apply a force to push the vacuum device 112 out of the apparatus 100 (e.g., the push to detach mechanism may apply a force to push the vacuum device 112 upwards out of the apparatus 100). Alternatively and/or additionally, responsive to applying a pushing force (e.g., a downwards pushing force) on the vacuum device 112, the vacuum device 112 may apply suction to conduct material into the collecting space 412.

In some examples, the vacuum device 112 may comprise a battery (e.g., a rechargeable battery). For example, the battery may be charged via the connection between the one or more second terminals 402 and the one or more first terminals of the vacuum device 112. In some examples, when the vacuum device 112 is detached from the apparatus 100 (and/or when the vacuum device 112 is attached to the apparatus 100), the vacuum device 112 may be electrically powered by the battery.

FIG. 4B illustrates a plurality of vacuum attachments 414. In some examples, a vacuum attachment of the plurality of vacuum attachments 414 may be attached to the opening 408 of the vacuum device 112. For example, the vacuum device 112 and/or the plurality of vacuum attachments 414 may be used for cleaning a tabletop and/or other areas.

FIGS. 4C a section of the apparatus 100 enclosing the tray 420. In some examples, the tray 420 may have an inwards curvature such that materials (e.g., shavings from the sharpener device 108 and/or chips from the hole puncher device 106) that fall into the tray 420 gravitate towards a section of the tray 420. The section of the tray 420 may correspond to a center of the tray 420. Alternatively and/or additionally, the section of the tray 420 may correspond to a section of the tray 420 below the opening 408 of the vacuum device 112 (such that material within the tray 420 is more efficiently conducted into the collecting space 412 by applying suction). FIG. 4D illustrates an embodiment of the tray 420. In some examples, the section of the tray 420 (e.g., the center of the tray 420) may have a lower elevation than one or more sides of the tray 420.

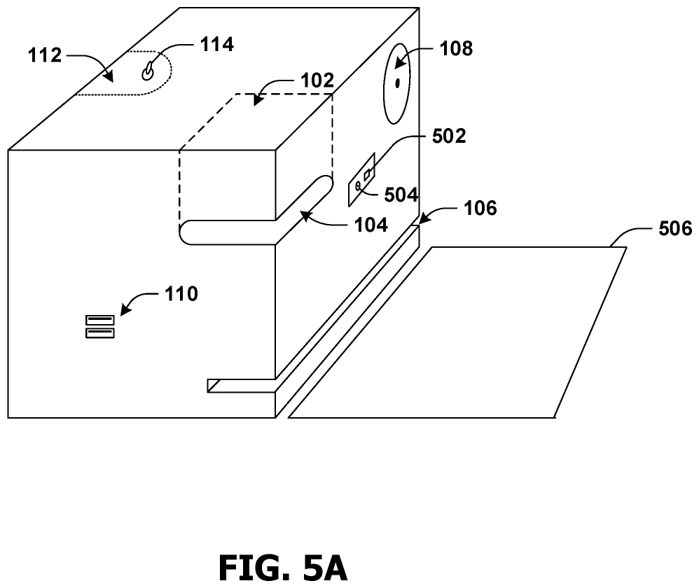

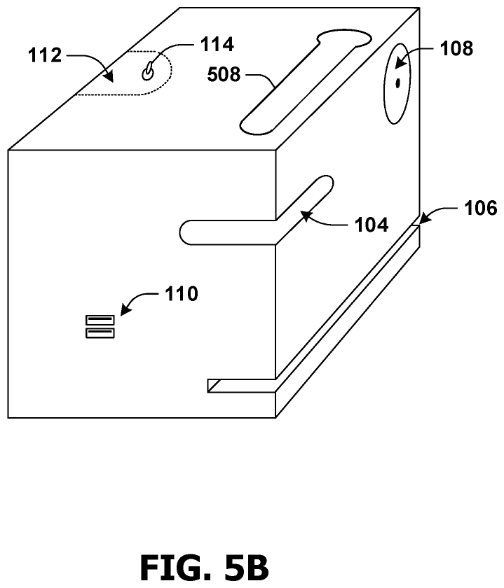

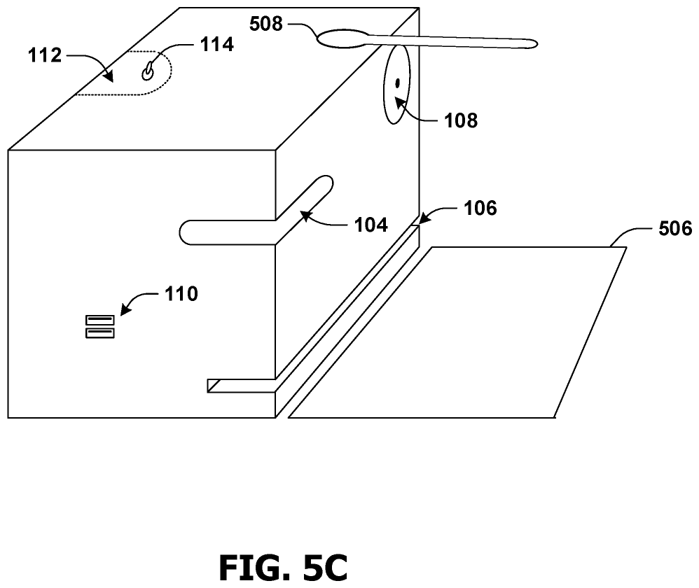

FIG. 5A illustrates a first embodiment of a scanning module of the apparatus 100. In the first embodiment of the scanning module, the scanning module may be positioned on the first side 1001 of the apparatus 100. In some examples, the scanning module may comprise a scanning device 504 and/or a projection module 502. In some examples, the scanning device 504 may be configured to scan a sheet of paper. For example, the scanning device 504 may capture an image of the sheet of paper. In some examples, the projection module 502 may be configured to project an outline 506 within which the sheet of paper should be placed in order to be properly scanned (e.g., a desktop and/or a tabletop on which the apparatus 100 is positioned). In some examples, a size and/or a shape of the outline 506 may be configured based upon one or more scanning settings. For example, the one or more scanning settings may correspond to at least one of a size of the sheet of paper, a shape of the sheet of paper, etc. The one or more scanning settings may be received via at least one of the graphical user interface, the conversational interface, the voice interface, the projection interface, etc. In some examples, the scanning device 504 may capture the image based upon the one or more scanning settings (e.g., the size of the sheet of paper and/or the shape of the sheet of paper) to capture the image comprising an entirety of the sheet of paper.

FIGS. 5B-5C illustrates a second embodiment of the scanning module of the apparatus 100. In the second embodiment of the scanning module, the scanning module (comprising the scanning device 504 and/or the projection module 502) may be positioned on a holder 508. In some examples, the holder 508 and/or the scanning module may be adjacent to the third side 1003 of the apparatus 100 (as shown in FIG. 5B). Alternatively and/or additionally, a position of the holder 508 may be adjusted such that a portion of the holder 508 and/or the scanning module extend over the surface on which the apparatus 100 is positioned (e.g., over the sheet of paper), as shown in FIG. 5C. In some examples, the scanning module may be coupled to a side of the handle 508 (e.g., an underside of the handle 508) facing the sheet of paper. Accordingly, the outline 506 may be projected and/or the image of the sheet of paper may be captured by the scanning module.

In some examples, the image of the sheet of paper (e.g., a scanned document) may be stored on the memory unit of the apparatus 100. Alternatively and/or additionally, the image of the sheet of paper may be transmitted to one or more client devices via at least one of a wired connection, the local area network, the public wide-area network (e.g., the Internet), the private network (e.g., the VPN), the wireless network provided by the cellular provider, the wireless local area network (e.g., the Wi-Fi network and/or the Bluetooth personal area network), etc. Alternatively and/or additionally, the image of the sheet of paper may be emailed to one or more email accounts. Alternatively and/or additionally, the image of the sheet of paper may be transmitted via messaging to one or more client devices.

FIGS. 6A-6B illustrate embodiments of the interface device 602 of the apparatus 100. In some examples, the interface device 602 may display the graphical user interface. In some examples, the graphical user interface may display information (e.g., the information may be indicative of one or more current settings associated with the apparatus 100, a status of a component of the apparatus 100, etc.) and/or one or more graphical selectable inputs. In some examples, the interface device 602 may be tiltable. For example, the interface device 602 may be tilted at an angle (as illustrated in FIG. 6B).

In some examples, the graphical user interface may display a calendar interface. For example, at least one of scheduled events, scheduled meetings, holidays, etc. may be displayed via the calendar interface. In some examples, at least one of the scheduled events, the scheduled meetings, the holidays, etc. may be determined based upon calendar information associated with a client device. In some examples, the calendar information may be associated with a user account associated with the client device (e.g., the calendar information may comprise one or more calendar entries associated with the user account). The calendar information may be received from the client device and/or from a server associated with the user account. Alternatively and/or additionally, the graphical user interface may display a calculator interface. The calculator interface may display selectable inputs corresponding to numbers and/or mathematical operators. For example, one or more calculations may be performed based upon inputs received via the calculator interface. A result of the one or more calculations may be displayed via the calculator interface.

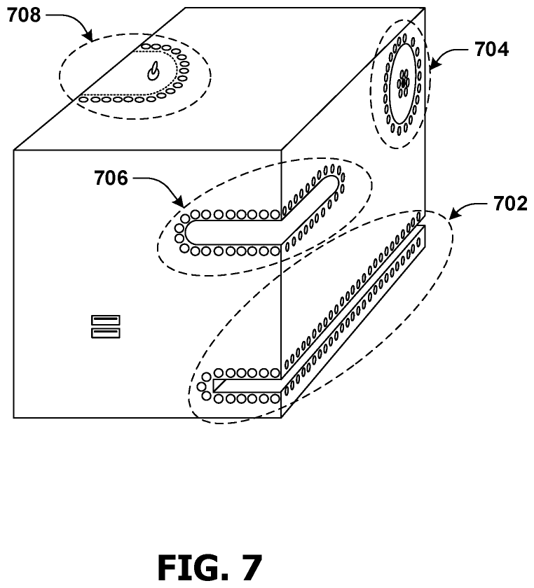

FIG. 7 illustrates an embodiment of the apparatus 100 comprising a second plurality of lights. In some examples, the second plurality of lights may comprise one or more first lights 702 associated with the hole puncher device 106, one or more second lights 704 associated with the sharpener device 108, one or more third lights 706 associated with the stapler device 102 and/or one or more fourth lights 708 associated with the vacuum device 112. In some examples, the one or more first lights 702 may surround the second indentation associated with the hole puncher device 106. Alternatively and/or additionally, the one or more second lights 704 may comprise one or more lights surrounding the opening of the sharpener device 108 and/or one or more lights surrounding the sharpener device 108. Alternatively and/or additionally, the one or more third lights 706 may surround the indentation 104. Alternatively and/or additionally, the one or more fourth lights 708 may surround the vacuum device 112.

In some examples, the second plurality of lights may be activated to enable usage of the apparatus 100 in dark environments. Alternatively and/or additionally, the second plurality of lights may be indicative of information associated with the one or more components of the apparatus 100. For example, one or more lights associated with a component of the one or more components may be activated (and/or deactivated) based upon a first state of the component (e.g., the first state may correspond to at least one of unsafe operation of the component, incorrect operation of the component, a mechanical failure of the component, an electrical failure of the component, a different state of the component, a status of the component, etc.). Alternatively and/or additionally, the one or more lights associated with the component may be deactivated (and/or activated) based upon a second state of the component (e.g., the second state may correspond to at least one of safe operation of the component, correct operation of the component, a different state of the component, a status of the component, etc.). Alternatively and/or additionally, the one or more lights may emit a first color (e.g., red and/or a different color) based upon the first state of the component and/or a second color (e.g., green and/or a different color) based upon the second state of the component. Alternatively and/or additionally, information indicative of the first state of the component and/or the second state of the component may be presented via at least one of the graphical user interface, the conversational interface, the voice interface, the projection interface, etc.

In an example, the one or more fourth lights 708 may be activated when the collecting space 412 is filled (and/or emptying the collecting space 412 is required) and/or may be deactivated when the collecting space 412 is not filled (and/or emptying the collecting space 412 is not required). Alternatively and/or additionally, the one or more fourth lights 708 may emit a first color (e.g., red and/or a different color) when the collecting space 412 is filled and/or may the one or more fourth lights 708 emit a second color (e.g., green and/or a different color) when the collecting space 412 is not filled. Alternatively and/or additionally, information indicative of whether the collecting space 412 is filled may be presented via at least one of the graphical user interface, the conversational interface, the voice interface, the projection interface, etc.

It may be appreciated that embodiments described herein are exemplary and/or illustrative, and that any combination of one or more of the components described herein are contemplated.

Unless specified otherwise, “first,” “second,” and/or the like are not intended to imply a temporal aspect, a spatial aspect, an ordering, discreteness, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B, at least one of A or B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An apparatus, comprising:
a sharpener device configured to sharpen a pencil, wherein the sharpener device is electrically powered by a first power source;
a tray configured to collect shavings from the sharpener device; and
a vacuum device configured to apply suction to conduct material from within the tray to a collecting space within the vacuum device, wherein:
the material comprises shavings within the tray; and
the vacuum device is electrically powered by the first power source.

2. The apparatus of claim 1, comprising:
a shutter device coupled to an opening of the sharpener device, wherein:
the sharpener device is configured for sharpening pencils having sizes of a first range of sizes from a first size to a second size;
an opening size of the opening of the sharpener device is larger than the second size such that a first pencil having a size of the first range of sizes fits inside the opening of the sharpener device; and
the shutter device is configured to enclose a portion of the first pencil to maintain the first pencil in a position responsive to insertion of the first pencil into the sharpener device, wherein the position corresponds to a center of the opening.

3. The apparatus of claim 2, wherein:
a first distance between a cutting module of the sharpener device and the opening is greater than a first length associated with a finger; and
the sharpener device is configured to:
sharpen the first pencil to a first sharpness based upon a first sharpness setting associated with a first level of sharpness; and
sharpen a second pencil to a second sharpness based upon a second sharpness setting associated with a second level of sharpness, wherein the second sharpness is different than the first sharpness.

4. The apparatus of claim 2, comprising:
a hole puncher device configured to punch one or more holes in one or more sheets of paper, wherein:
the hole puncher device is electrically powered by the first power source;
the tray is configured to collect chips from the hole puncher device; and
the material comprises chips within the tray.

5. An apparatus, comprising:
a hole puncher device configured to punch one or more holes in one or more sheets of paper, wherein the hole puncher device is electrically powered by a first power source;
a tray configured to collect chips from the hole puncher device; and
a vacuum device configured to apply suction to conduct material from within the tray to a collecting space within the vacuum device, wherein:
the material comprises chips within the tray; and
the vacuum device is electrically powered by the first power source.

6. The apparatus of claim 5, wherein:
the hole puncher device comprises a plurality of punches; and
the hole puncher device is configured to:
hole punch one or more first sheets of paper using a first set of punches of the plurality of punches to produce a first set of holes in the one or more first sheets of paper based upon a first hole configuration; and
hole punch one or more second sheets of paper using a second set of punches of the plurality of punches to produce a second set of holes in the one or more second sheets of paper based upon a second hole configuration, wherein a first quantity of punches of the first set of punches is different than a second quantity of punches of the second set of punches.

7. The apparatus of claim 6, comprising:
a plurality of lights, wherein each light of the plurality of lights is associated with a punch of the plurality of punches; and
a controller configured to:
activate a first set of lights, associated with the first set of punches, of the plurality of lights responsive to a hole configuration setting of the hole puncher device corresponding to the first hole configuration, wherein activation of the first set of lights is indicative of the first hole configuration; and
activate a second set of lights, associated with the second set of punches, of the plurality of lights responsive to the hole configuration setting of the hole puncher device corresponding to the second hole configuration, wherein activation of the second set of lights is indicative of the second hole configuration.

8. The apparatus of claim 6, comprising:
a sharpener device configured to sharpen a pencil, wherein the sharpener device is electrically powered by the first power source; and
a shutter device coupled to an opening of the sharpener device, wherein:
the sharpener device is configured for sharpening pencils having sizes of a first range of sizes from a first size to a second size;
an opening size of the opening of the sharpener device is larger than the second size such that a first pencil having a size of the first range of sizes fits inside the opening of the sharpener device;
the shutter device is configured to enclose a portion of the first pencil to maintain the first pencil in a position responsive to insertion of the first pencil into the sharpener device, wherein the position corresponds to a center of the opening;
the tray is configured to collect shavings from the sharpener device; and
the material comprises shavings within the tray.

9. An apparatus, comprising:
a hole puncher device configured to punch one or more holes in one or more sheets of paper, wherein the hole puncher device is electrically powered by a first power source; and
a sharpener device configured to sharpen a pencil, wherein the sharpener device is electrically powered by the first power source.

10. The apparatus of claim 9, comprising:
a tray configured to collect shavings from the sharpener device and chips from the hole puncher device; and
a vacuum device configured to apply suction to conduct material from within the tray to a collecting space within the vacuum device, wherein the material comprises shavings and chips within the tray.

11. The apparatus of claim 9, comprising:
a shutter device coupled to an opening of the sharpener device, wherein:
the sharpener device is configured for sharpening pencils having sizes of a first range of sizes from a first size to a second size;
an opening size of the opening of the sharpener device is larger than the second size such that a first pencil having a size of the first range of sizes fits inside the opening of the sharpener device;
the shutter device is configured to enclose a portion of the first pencil to maintain the first pencil in a position responsive to insertion of the first pencil into the sharpener device, wherein the position corresponds to a center of the opening;
the hole puncher device comprises a plurality of punches; and
the sharpener device is configured to:
hole punch one or more first sheets of paper using a first set of punches of the plurality of punches to produce a first set of holes in the one or more first sheets of paper based upon a first hole configuration; and
hole punch one or more second sheets of paper using a second set of punches of the plurality of punches to produce a second set of holes in the one or more second sheets of paper based upon a second hole configuration, wherein a first quantity of punches of the first set of punches is different than a second quantity of punches of the second set of punches.

12. The apparatus of claim 11, comprising:
a plurality of lights, wherein each light of the plurality of lights is associated with a punch of the plurality of punches; and
a controller configured to:
activate a first set of lights, associated with the first set of punches, of the plurality of lights responsive to a hole configuration setting of the hole puncher device corresponding to the first hole configuration, wherein activation of the first set of lights is indicative of the first hole configuration; and
activate a second set of lights, associated with the second set of punches, of the plurality of lights responsive to the hole configuration setting of the hole puncher device corresponding to the second hole configuration, wherein activation of the second set of lights is indicative of the second hole configuration, wherein:
a first distance between a cutting module of the sharpener device and the opening is greater than a first length associated with a finger.

13. An apparatus, comprising:
a sharpener device configured to sharpen a pencil, wherein the sharpener device is electrically powered by a first power source;
an indentation at a corner of the apparatus; and
a stapler device overlying the indentation, wherein:
the stapler device is configured to couple sheets of paper together by driving a staple through the sheets of paper at a point within the indentation; and
the stapler device is electrically powered by the first power source.

14. The apparatus of claim 13, comprising:
a shutter device coupled to an opening of the sharpener device, wherein:
the sharpener device is configured for sharpening pencils having sizes of a first range of sizes from a first size to a second size;
an opening size of the opening of the sharpener device is larger than the second size such that a first pencil having a size of the first range of sizes fits inside the opening of the sharpener device; and
the shutter device is configured to enclose a portion of the first pencil to maintain the first pencil in a position responsive to insertion of the first pencil into the sharpener device, wherein the position corresponds to a center of the opening.

15. The apparatus of claim 14, comprising:
a tray configured to collect shavings from the sharpener device; and
a vacuum device configured to apply suction to conduct material from within the tray to a collecting space within the vacuum device, wherein the material comprises shavings within the tray.

16. The apparatus of claim 15, comprising:
a hole puncher device configured to punch one or more holes in one or more sheets of paper, wherein:
the hole puncher device is electrically powered by the first power source;
the tray is configured to collect chips from the hole puncher device; and
the material comprises chips within the tray.

17. An apparatus, comprising:
a hole puncher device configured to punch one or more holes in one or more sheets of paper, wherein the hole puncher device is electrically powered by a first power source;
an indentation at a corner of the apparatus; and
a stapler device overlying the indentation, wherein:
the stapler device is configured to couple sheets of paper together by driving a staple through the sheets of paper at a point within the indentation; and
the stapler device is electrically powered by the first power source.

18. The apparatus of claim 17, comprising:
a tray configured to collect chips from the hole puncher device; and
a vacuum device configured to apply suction to conduct material from within the tray to a collecting space within the vacuum device, wherein the material comprises chips within the tray.

19. The apparatus of claim 18, wherein:
the hole puncher device comprises a plurality of punches; and
the hole puncher device is configured to:
hole punch one or more first sheets of paper using a first set of punches of the plurality of punches to produce a first set of holes in the one or more first sheets of paper based upon a first hole configuration; and
hole punch one or more second sheets of paper using a second set of punches of the plurality of punches to produce a second set of holes in the one or more second sheets of paper based upon a second hole configuration, wherein a first quantity of punches of the first set of punches is different than a second quantity of punches of the second set of punches.

20. The apparatus of claim 19, comprising:
a plurality of lights, wherein each light of the plurality of lights is associated with a punch of the plurality of punches;
a controller configured to:
activate a first set of lights, associated with the first set of punches, of the plurality of lights responsive to a hole configuration setting of the hole puncher device corresponding to the first hole configuration, wherein activation of the first set of lights is indicative of the first hole configuration; and
activate a second set of lights, associated with the second set of punches, of the plurality of lights responsive to the hole configuration setting of the hole puncher device corresponding to the second hole configuration, wherein activation of the second set of lights is indicative of the second hole configuration;
a sharpener device configured to sharpen a pencil, wherein the sharpener device is electrically powered by the first power source; and
a shutter device coupled to an opening of the sharpener device, wherein:
the sharpener device is configured for sharpening pencils having sizes of a first range of sizes from a first size to a second size;
an opening size of the opening of the sharpener device is larger than the second size such that a first pencil having a size of the first range of sizes fits inside the opening of the sharpener device; and
the shutter device is configured to enclose a portion of the first pencil to maintain the first pencil in a position responsive to insertion of the first pencil into the sharpener device, wherein the position corresponds to a center of the opening.
